(19) United States
(12) Patent Application Publication
(10) Pub. No.: US 2026/0335723 A1
(43) Pub. Date: Oct. 29, 2026

(54) CHAIN-STYLE BOWLING BALL SUPPORT ASSEMBLY

(71) Applicant: Antany D. Peppers, Columbus, OH (US)

(72) Inventor: Antany D. Peppers, Columbus, OH (US)

(21) Appl. No.: 19/636,866

(22) Filed: Apr. 1, 2026

Related U.S. Application Data
(60) Provisional application No. 63/794,494, filed on Apr. 25, 2025.
(60) Provisional application No. 63/794,507, filed on Apr. 25, 2025.
(60) Provisional application No. 63/794,516, filed on Apr. 25, 2025.

(51) Int. Cl. A63B 47/00

(52) U.S. Cl. CPC A63B 47/007

(57) ABSTRACT

A bowling ball support assembly comprising a plurality of interconnected link assemblies, each link assembly comprising a support platform. A bearing assembly is coupled to each support platform, wherein the bearing assemblies are configured to contact and rotationally support a bowling ball when the link assemblies are in a radial configuration. Each link assembly comprises a first outer connection member and a second outer connection member extending laterally in parallel from the support platform, and an inner connection member extending from the support platform on an opposite side, configured to be positioned between the outer connection members of an adjacent link assembly. A closure mechanism is configured to selectively secure the link assemblies in the radial configuration, wherein the link assemblies are transitionable between the radial configuration and a linear configuration for storage.

### CROSS-REFERENCE TO RELATED APPLICATIONS

This application claims the benefit of U.S. Provisional Patent Application Nos. 63/794,494, 63/794,507, and 63/794,516, filed on Apr. 25, 2025, which are incorporated herein by reference in their entirety.

### FIELD OF INVENTION

The present disclosure relates to bowling ball support systems, and more particularly to a chain-style bowling ball support assembly with interconnected link assemblies.

### BACKGROUND

Bowling is a popular recreational activity enjoyed by millions of people worldwide. The sport involves rolling a heavy ball down a lane to knock over a set of pins. A bowling ball typically weighs between 6 to 16 pounds and has a smooth, spherical surface with finger holes drilled into it. Transporting and handling bowling balls can present challenges due to their substantial weight and perfectly round shape. Bowlers often move their balls between storage areas, vehicles, and bowling alleys. Additionally, regular cleaning and maintenance of bowling balls is beneficial for performance, as bowlers may clean all surfaces of the ball to remove lane oil, dirt, and debris that accumulate during play.

Various devices and systems have been developed to assist with bowling ball transportation, handling, and cleaning. These include wheeled carrying bags, ball carts, and stationary ball holders or cradles. However, many existing solutions have limitations in terms of portability, ease of use, or ability to allow free rotation of the ball for thorough cleaning, polishing, and maintenance purposes.

Portable ball holders that can securely support a bowling ball while allowing it to be rotated are useful for bowlers who perform regular cleaning routines. Such devices enable convenient and effective cleaning, polishing, and inspection of the ball's surface, including hard-to-reach areas. Proper cleaning removes oil absorption patterns that can affect ball performance. Designing a holder that is both stable enough to securely support a heavy bowling ball during vigorous cleaning and compact enough for easy transport presents engineering challenges.

Some existing bowling ball support devices utilize fixed configurations that may not readily adapt to different storage or transport requirements. Other devices may employ cup-shaped supports that provide rotational capability but may have limitations regarding portability or the ability to transition between different configurations.

There remains room for improvement in bowling ball support systems that offer a combination of portability, stability, and functionality for cleaning operations. Advancements in this area could benefit bowlers by making ball maintenance, cleaning, and transportation more convenient, potentially encouraging more frequent play and proper equipment care. A system that allows for rotation during cleaning would help ensure that surfaces of the ball receive attention, which may extend the life and consistent performance of the bowling ball.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a bowling ball support assembly for supporting a bowling ball is provided. The bowling ball support assembly includes a plurality of interconnected link assemblies, each link assembly comprising a support platform. A bearing assembly is coupled to each support platform, wherein the bearing assemblies are configured to contact and rotationally support a bowling ball when the link assemblies are in a radial configuration. A closure mechanism is configured to selectively secure the link assemblies in the radial configuration, wherein the link assemblies are transitionable between the radial configuration and a linear configuration.

According to other aspects of the present disclosure, the bowling ball support assembly may include one or more of the following features. Each link assembly may comprise a first outer connection member, a second outer connection member positioned in parallel to the first outer connection member, wherein the first outer connection member and the second outer connection member extend laterally in parallel from the support platform, and an inner connection member extending from the support platform on an opposite side from the first outer connection member and the second outer connection member, wherein the inner connection member is configured to be positioned between the first outer connection member and the second outer connection member of an adjacent link assembly. The first outer connection member and the second outer connection member may each comprise an outer member hole forming an axis of rotation, and a bearing pin may extend through the outer member holes to connect adjacent link assemblies. The bearing pin may comprise a bearing pin head at one end and a bearing pin nut at an opposite end, wherein the bearing pin head is configured to seat within a bearing pin head seat flush below a top surface of the first outer connection member, and wherein the bearing pin nut is configured to seat within a bearing pin nut seat flush above a bottom surface of the second outer connection member. The inner connection member may comprise a roller seat configured to receive a roller that is operably rotatable therewithin. The roller may be positioned between the first outer connection member and the second outer connection member of an adjacent link assembly and may be rotatable within the roller seat. The bowling ball support assembly may further comprise angled stop plates positioned between adjacent link assemblies to limit a range of motion between the adjacent link assemblies. The support platform of each link assembly may include a bottom flat surface, wherein the bottom flat surface of each support platform provides a stable base when the bowling ball support assembly is placed on a supporting surface by distributing the weight of the bowling ball across the plurality of link assemblies. The closure mechanism may comprise an engagement member configured to engage with a roller seat of an adjacent link assembly to allow the bowling ball support assembly to be opened and closed.

According to another aspect of the present disclosure, a bowling ball support assembly is provided. The bowling ball support assembly includes a plurality of interconnected link assemblies arranged in a chain formation, each link assembly comprising a roller ball bearing support platform configured to support a roller ball bearing assembly, a first outer connection member and a second outer connection member extending laterally in parallel from the roller ball bearing support platform, and an inner connection member extending from the roller ball bearing support platform opposite the first outer connection member and the second outer connection member, the inner connection member configured to be positioned between the first outer connection member and the second outer connection member of an adjacent link assembly. A roller ball bearing assembly is coupled to each roller ball bearing support platform. A master link assembly is configured to allow the chain formation to be opened and closed, wherein the link assemblies are configurable between a radial configuration for supporting a bowling ball and a linear configuration for storage.

According to other aspects of the present disclosure, the bowling ball support assembly may include one or more of the following features. The first outer connection member and the second outer connection member may each comprise an outer member hole, and a bearing pin may extend through the outer member holes to connect adjacent link assemblies. The bearing pin may comprise a bearing pin head at one end and a bearing pin nut at an opposite end, wherein the bearing pin head is configured to seat within a bearing pin head seat flush below a top surface of the first outer connection member, and wherein the bearing pin nut is configured to seat within a bearing pin nut seat flush above a bottom surface of the second outer connection member. The inner connection member may comprise an inner member roller seat configured to receive a roller that is operably rotatable therewithin. The roller may be positioned between the first outer connection member and the second outer connection member of an adjacent link assembly and may be rotatable within the inner member roller seat to provide an axis of rotation between adjacent link assemblies. The bowling ball support assembly may further comprise angled stop plates positioned between adjacent link assemblies to limit a range of motion between the adjacent link assemblies. The master link assembly may comprise a master link outer member and a master link mounting cylinder extending from the master link outer member, wherein the master link mounting cylinder is configured to engage with an inner member roller seat of an adjacent link assembly.

According to another aspect of the present disclosure, a bowling ball support assembly is provided. The bowling ball support assembly includes a plurality of interconnected link assemblies arranged in a pentagonal configuration, each link assembly comprising a roller ball bearing support platform having a bottom flat surface, a first outer connection member and a second outer connection member positioned in parallel and extending laterally from the roller ball bearing support platform, each of the first outer connection member and the second outer connection member comprising an outer member hole forming an axis of rotation, an inner connection member extending from the roller ball bearing support platform opposite the first outer connection member and the second outer connection member, the inner connection member comprising an inner member roller seat and a roller received within the inner member roller seat and rotatable therewithin, and a bearing pin extending through the outer member holes to connect adjacent link assemblies. A roller ball bearing assembly is coupled to each roller ball bearing support platform, wherein the roller ball bearing assemblies are arranged in an inwardly angled radial pattern to support a bowling ball in a rotational manner. Angled stop plates are positioned between adjacent link assemblies to limit a range of motion between the adjacent link assemblies. A master link assembly comprises a master link mounting cylinder configured to engage with an inner member roller seat of an adjacent link assembly to allow the support assembly to be opened and closed.

According to other aspects of the present disclosure, the bowling ball support assembly may include one or more of the following features. The bearing pin may comprise a bearing pin head at one end and a bearing pin nut at an opposite end, wherein the bearing pin head is configured to seat within a bearing pin head seat flush below a top surface of the first outer connection member, and wherein the bearing pin nut is configured to seat within a bearing pin nut seat flush above a bottom surface of the second outer connection member. The roller may be positioned between the first outer connection member and the second outer connection member of an adjacent link assembly and may be rotatable within the inner member roller seat to provide an axis of rotation between adjacent link assemblies. The bottom flat surface of each roller ball bearing support platform may provide a stable base when the support assembly is placed on a supporting surface by distributing the weight of the bowling ball across the plurality of link assemblies.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a top perspective view of a chain support assembly configured in a chain-closed, radial arrangement when in the engaged configuration, in accordance with an aspect of the present disclosure;

FIG. 2 is a bottom perspective view of the chain support assembly of FIG. 1, in accordance with an aspect of the present disclosure;

FIG. 3 is a top plan view of the chain support assembly of FIG. 1, in accordance with an aspect of the present disclosure;

FIG. 4 is a bottom plan view of the chain support assembly of FIG. 1, in accordance with an aspect of the present disclosure;

FIG. 5 is a side elevation view of the chain support assembly of FIG. 1, in accordance with an aspect of the present disclosure;

FIG. 6 is a cross-sectional view of the chain support assembly of FIG. 1, in accordance with an aspect of the present disclosure;

FIG. 7 is a top exterior side perspective view of a link assembly of the chain support assembly, in accordance with an aspect of the present disclosure;

FIG. 8 is a bottom interior side perspective view of the link assembly of FIG. 7, in accordance with an aspect of the present disclosure;

FIG. 9 is a top plan view of the link assembly of FIG. 7, in accordance with an aspect of the present disclosure;

FIG. 10 is a bottom plan view of the link assembly of FIG. 7, in accordance with an aspect of the present disclosure;

FIG. 11 is an interior side elevation view of the link assembly of FIG. 7, in accordance with an aspect of the present disclosure;

FIG. 12 is an interior side top perspective view of a master link assembly, in accordance with an aspect of the present disclosure;

FIG. 13 is an interior side bottom perspective view of the master link assembly of FIG. 12, in accordance with an aspect of the present disclosure;

FIG. 14 is a top plan view of the master link assembly of FIG. 12, in accordance with an aspect of the present disclosure;

FIG. 15 is a bottom plan view of the master link assembly of FIG. 12, in accordance with an aspect of the present disclosure;

FIG. 16 is an interior elevation view of the master link assembly of FIG. 12, in accordance with an aspect of the present disclosure;

FIG. 17 is an exploded perspective view of a first link assembly and a partially assembled perspective view of a second link assembly of FIG. 7, in accordance with an aspect of the present disclosure;

FIG. 18 is a top perspective view of the chain support assembly in an extended linear chain-open configuration, in accordance with an aspect of the present disclosure;

FIG. 19 is a bottom perspective view of the chain support assembly in an extended linear chain-open configuration, in accordance with an aspect of the present disclosure;

FIG. 20 is a bottom perspective view of the chain support assembly in a chain-open radial arrangement, in accordance with an aspect of the present disclosure; and

FIG. 21 is a perspective view of the chain support assembly with a bowling ball positioned thereon, in accordance with an aspect of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

As used herein, the term “support platform” may refer broadly to any platform configured to support a bearing assembly. While the detailed description primarily describes a “roller ball bearing support platform” configured to support a roller ball bearing assembly, the term “support platform” may encompass platforms configured to support other types of bearing assemblies, including but not limited to roller bearing assemblies, needle bearing assemblies, or other bearing types suitable for rotationally supporting a bowling ball.

As used herein, the term “bearing assembly” may refer broadly to any assembly configured to rotationally support a bowling ball. While the detailed description primarily describes a “roller ball bearing assembly” containing a ball configured to rotate freely, the term “bearing assembly” may encompass other types of bearing assemblies, including but not limited to roller bearing assemblies, needle bearing assemblies, or other bearing types suitable for rotationally supporting a bowling ball.

As used herein, the term “engagement member” may refer broadly to any member configured to engage with a corresponding feature of an adjacent link assembly to allow a chain support assembly to be opened and closed. While the detailed description primarily describes a “master link mounting cylinder” configured to engage with an inner member roller seat of an adjacent link assembly, the term “engagement member” may encompass other types of engagement members, including but not limited to cylindrical projections, pins, latches, or other engagement features suitable for selectively securing link assemblies in a closed configuration.

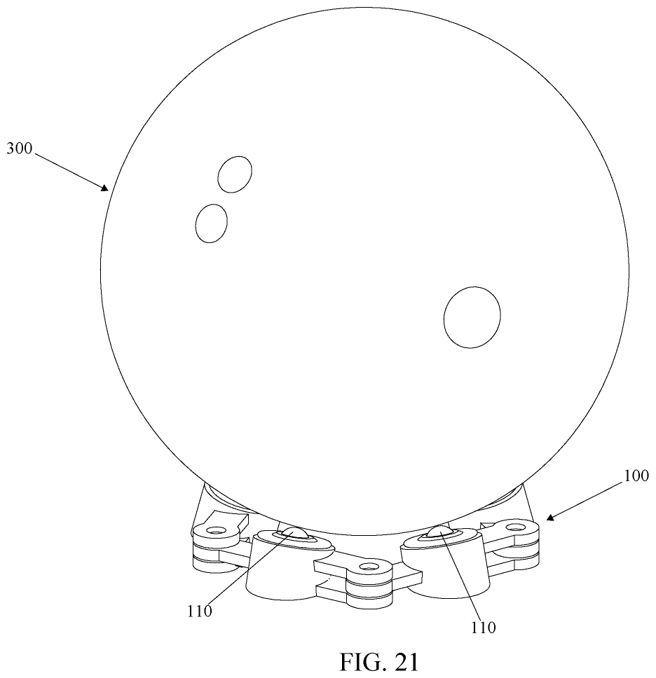

Referring to FIG. 21, a bowling ball 300 is shown positioned on a bowling ball support assembly 100. The bowling ball 300 may be a spherical object featuring finger holes on a surface thereof. The bowling ball support assembly 100 may be configured to support the bowling ball 300 in a stable manner while permitting free rotation of the bowling ball 300 for cleaning, polishing, and maintenance purposes.

With continued reference to FIG. 21, the bowling ball support assembly 100 may comprise a plurality of interconnected link assemblies arranged in a radial configuration beneath the bowling ball 300. Each link assembly may include a roller ball bearing assembly containing a ball 110 that contacts an underside of the bowling ball 300. The balls 110 may be positioned in an inwardly angled radial pattern to provide rotational support for the bowling ball 300, allowing the bowling ball 300 to be rotated freely during cleaning or maintenance operations. The bowling ball support assembly 100 may cradle the bowling ball 300 with the roller ball bearing assemblies distributed around a perimeter of the radial arrangement. The equally spaced arrangement of the roller ball bearing assemblies may maintain enough contact points with the bowling ball 300 to provide stable support, avoid slippage of the bowling ball 300 into a finger hole, and permit smooth rotation of the bowling ball 300 in any direction.

The chain-style design of the bowling ball support assembly 100 may provide several advantages. The bowling ball support assembly 100 may be configured to transition between a radial configuration for supporting the bowling ball 300 and a linear configuration for compact storage and transport. In the radial configuration, the link assemblies may form a pentagonal arrangement that provides stable support for the bowling ball 300 while allowing for smooth rotation thereof. In the linear configuration, the link assemblies may be arranged in a sequential chain formation that facilitates compact storage and convenient transportation of the bowling ball support assembly 100. This dual-configuration capability may allow users to easily store and transport the bowling ball support assembly 100 when not in use, while providing a stable and functional support platform when deployed for bowling ball maintenance activities.

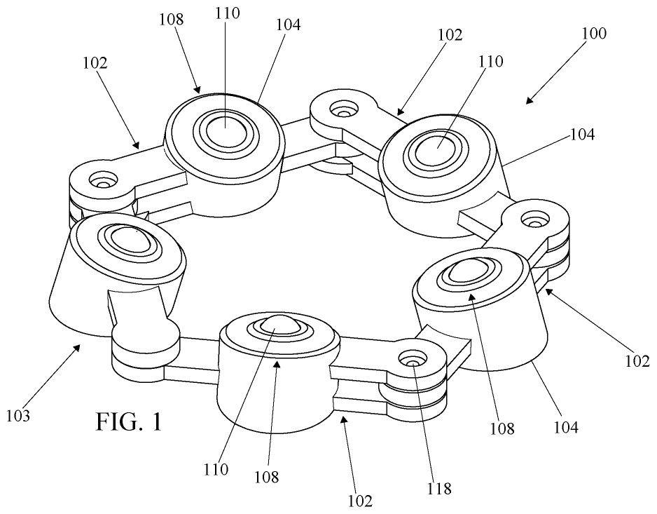

Referring to FIG. 1, the bowling ball support assembly 100 is shown in a top perspective view configured in a radial arrangement for supporting a bowling ball. The bowling ball support assembly 100 may comprise a plurality of interconnected link assemblies 102 and a master link assembly 103 arranged in a pentagonal configuration. Each link assembly 102 may include a roller ball bearing support platform 104 that supports a roller ball bearing assembly 108. Each roller ball bearing assembly 108 may contain a ball 110 that is positioned to contact and support a bowling ball placed on the bowling ball support assembly 100. The roller ball bearing assemblies 108 may be arranged in a radial pattern to support a bowling ball in a rotational manner when the link assemblies 102 are in the radial configuration.

With continued reference to FIG. 1, the link assemblies 102 may be connected to adjacent link assemblies 102 to form the pentagonal configuration. The master link assembly 103 may be positioned within the pentagonal arrangement and may be configured to allow the bowling ball support assembly 100 to be opened and closed, enabling transition between the radial configuration shown and a linear configuration for storage. The master link assembly 103 may also be referred to as a closure mechanism. The roller ball bearing assemblies 108 may be arranged in an inwardly angled radial pattern, with the balls 110 positioned to provide rotational support for a bowling ball placed on the bowling ball support assembly 100.

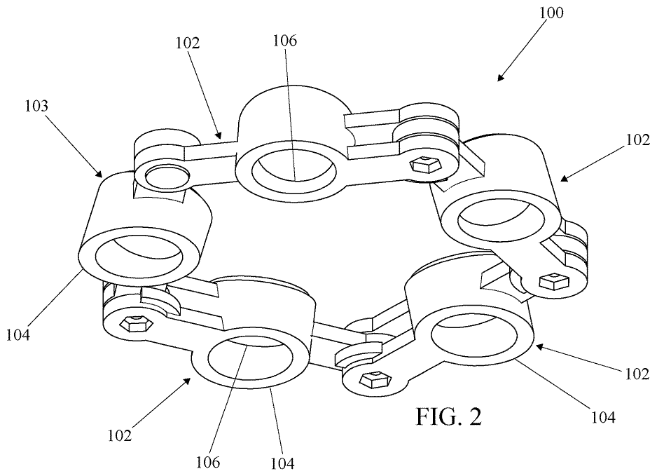

Referring to FIG. 2, a bottom perspective view of the bowling ball support assembly 100 is depicted. The bowling ball support assembly 100 may comprise the plurality of interconnected link assemblies 102 arranged in the radial configuration. Each link assembly 102 may include the roller ball bearing support platform 104 positioned to support a portion of a bowling ball when the bowling ball support assembly 100 is in use. The roller ball bearing support platforms 104 may be oriented to angle inwardly toward a center of the radial arrangement. A roller ball bearing assembly 108 may be coupled to each roller ball bearing support platform 104. The link assemblies 102 may be arrangeable in the radial configuration to support a bowling ball and in a linear configuration for storage. The master link assembly 103 may be configured to allow the bowling ball support assembly 100 to be opened and closed, facilitating transition between the radial configuration shown and the linear configuration for storage.

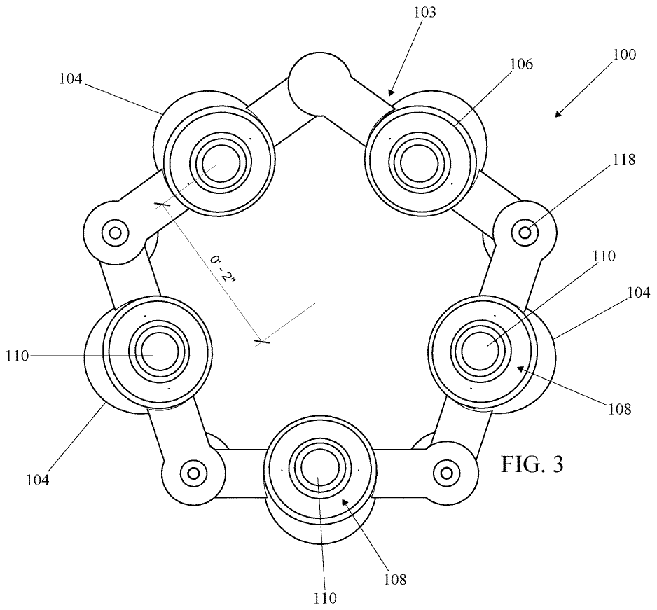

Referring to FIG. 3, a top plan view of the bowling ball support assembly 100 in the pentagonal configuration is shown. The bowling ball support assembly 100 may include multiple roller ball bearing support platforms 104 arranged in a radial pattern to form a five-sided shape. Each roller ball bearing support platform 104 may include a roller ball bearing assembly seat 106 that receives the roller ball bearing assembly 108 therein. The roller ball bearing assembly seats 106 may be configured to receive and retain the roller ball bearing assemblies 108 in a secure manner. The roller ball bearing assemblies 108 may each contain the ball 110 that is visible from the top view. The roller ball bearing assemblies 108 may be positioned to face inwardly toward a center of the pentagonal configuration, enabling rotational support for a bowling ball placed on the bowling ball support assembly 100.

With continued reference to FIG. 3, adjacent roller ball bearing support platforms 104 may be connected by bearing pins 118. The bearing pins 118 may extend through connection points between the roller ball bearing support platforms 104 to allow pivoting movement between adjacent link assemblies 102 and master link assembly 103. The master link assembly 103 may be positioned at a location within the pentagonal arrangement, providing a connection point that allows the bowling ball support assembly 100 to be opened and closed. The pentagonal configuration shown may provide a radial arrangement where the roller ball bearing assemblies 108 are equally spaced around a perimeter, maintaining the balls 110 as contact points to support a bowling ball while allowing the bowling ball to rotate freely for cleaning or maintenance purposes.

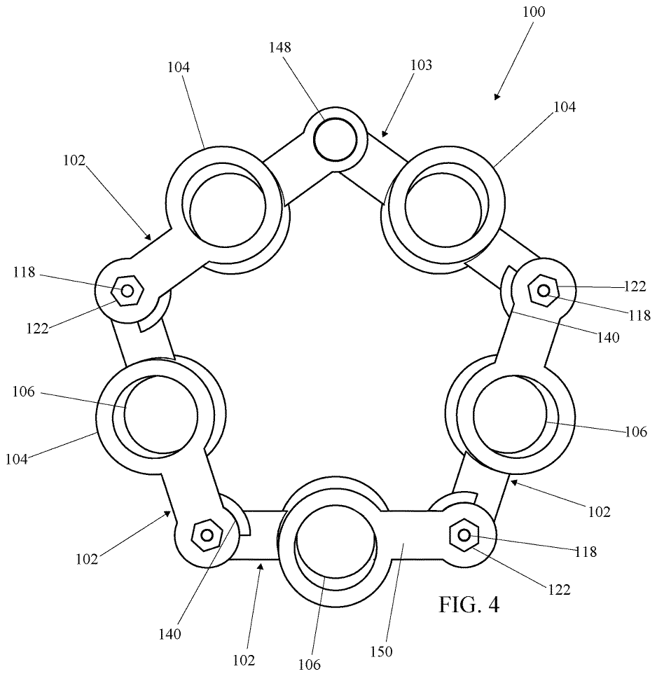

Referring to FIG. 4, a bottom plan view of the bowling ball support assembly 100 in the pentagonal arrangement is depicted. The bowling ball support assembly 100 may comprise the plurality of interconnected link assemblies 102 and the master link assembly 103 arranged in the radial configuration suitable for supporting a bowling ball. Each link assembly 102 may include the roller ball bearing support platform 104 positioned centrally within the link assembly 102. The roller ball bearing support platforms 104 may each include the roller ball bearing assembly seat 106 configured to receive and retain the roller ball bearing assembly 108.

With continued reference to FIG. 4, angled stop plates 140 may be positioned between adjacent link assemblies 102. The angled stop plates 140 may limit a range of motion between the adjacent link assemblies 102, helping to maintain the desired pentagonal configuration when supporting a bowling ball. The angled stop plates 140 may provide controlled movement and stability to the overall structure of the bowling ball support assembly 100 by restricting the angular displacement between interconnected link assemblies 102.

As further shown in FIG. 4, the master link assembly 103 may include a master link mounting cylinder 148 that extends from the master link assembly 103 to engage with an adjacent link assembly 102. The master link mounting cylinder 148 may allow the bowling ball support assembly 100 to be opened and closed for transitioning between the radial configuration shown and the linear configuration for storage. The master link mounting cylinder 148 may be configured to engage with an inner member roller seat of the adjacent link assembly 102, providing a secure yet releasable connection. The interlocking tolerance precision between the master link mounting cylinder 148 and the inner member roller seat may be configured such that the bowling ball support assembly 100 remains intact through tension when lifted. When a bowling ball is placed on the bowling ball support assembly 100, the downward force of the bowling ball may force the components to equilibrium, further securing the connection between the master link assembly 103 and the adjacent link assembly 102.

With continued reference to FIG. 4, each of the link assembly 102 and master link assembly 103 may include a bottom flat surface 150. The bottom flat surfaces 150 collectively provide a stable base when the bowling ball support assembly 100 is placed on a supporting surface. The bottom flat surfaces 150 may distribute the weight of the bowling ball across the plurality of link assemblies 102, providing stability during cleaning or maintenance operations.

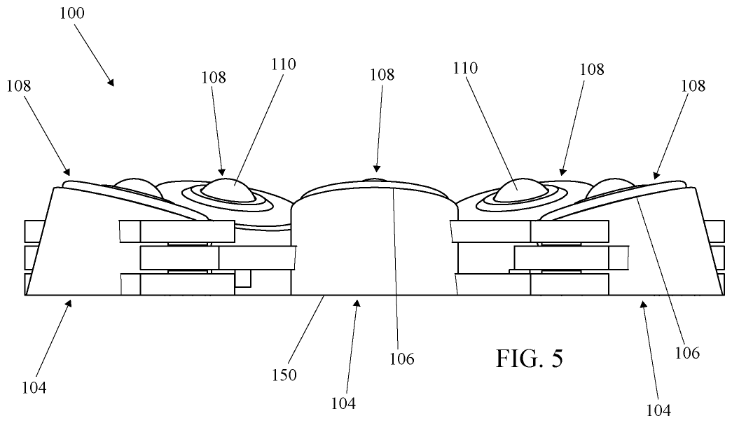

Referring to FIG. 5, a side elevation view of the bowling ball support assembly 100 is i llustrated. The bowling ball support assembly 100 is shown in the radial configuration. Each link assembly 102 may include the roller ball bearing support platform 104 positioned centrally within the structure. The roller ball bearing support platforms 104 may each include the roller ball bearing assembly seat 106 configured to receive and retain the roller ball bearing assembly 108. Each roller ball bearing assembly 108 contains the ball 110 that extends above the roller ball bearing support platform 104, with the balls 110 positioned in a radial manner to provide contact points for supporting a bowling ball placed on the bowling ball support assembly 100.

With continued reference to FIG. 5, the roller ball bearing support platforms 104 may be oriented at an inward angle toward a center of the radial arrangement, which may help to cradle and center a bowling ball when placed on the bowling ball support assembly 100. Each link assembly 102 and master link assembly 103 may include the bottom flat surface 150 that provides stability when the bowling ball support assembly 100 is placed on a supporting surface. The side elevation view reveals a vertical profile of the bowling ball support assembly 100, showing how the roller ball bearing assemblies 108 with the balls 110 are elevated above the bottom flat surfaces 150 to properly engage with and support a bowling ball during cleaning or maintenance operations.

Referring to FIG. 6, a sectional elevation view of the bowling ball support assembly 100 is shown in its assembled position. The bowling ball support assembly 100 may comprise the plurality of interconnected link assemblies 102 arranged in a radial formation to support a bowling ball. Each link assembly 102 may include the roller ball bearing support platform 104 positioned centrally within the structure. The roller ball bearing support platforms 104 may each include the roller ball bearing assembly seat 106 configured to receive and retain the roller ball bearing assembly 108. Each roller ball bearing assembly 108 may contain the ball 110 that extends above the roller ball bearing support platform 104. The roller ball bearing assembly 108 may be seated within the roller ball bearing assembly seat 106, with the ball 110 extending upwardly to provide a contact surface for the bowling ball.

With continued reference to FIG. 6, each link assembly 102 may comprise a first outer connection member 112 and a second outer connection member 114. The second outer connection member 114 may be positioned in parallel to the first outer connection member 112. The first outer connection member 112 and the second outer connection member 114 may extend laterally in parallel from the roller ball bearing support platform 104, forming part of a structural framework of the link assembly 102.

As further shown in FIG. 6, each link assembly 102 may comprise an inner connection member 116 extending from the roller ball bearing support platform 104 on an opposite side from the first outer connection member 112 and the second outer connection member 114. The inner connection member 116 may be configured to be positioned between the first outer connection member 112 and the second outer connection member 114 of an adjacent link assembly 102, allowing for interconnection between link assemblies 102 in the chain-style arrangement. This configuration may enable the link assemblies 102 to be connected in a sequential chain formation where the inner connection member 116 of one link assembly 102 is received and sandwiched between the first outer connection member 112 and the second outer connection member 114 of an adjacent link assembly 102.

With continued reference to FIG. 6, adjacent link assemblies 102 may be connected via a bearing pin 118. The bearing pin 118 may extend through connection points between the link assemblies 102 to provide an axis of rotation. The bearing pin 118 may comprise a bearing pin head 120 at one end and a bearing pin nut 122 at an opposite end. The bearing pin head 120 may be configured to seat flush below a top surface of the first outer connection member 112. The bearing pin nut 122 may be configured to seat flush above a bottom surface of the second outer connection member 114. This configuration may allow for a secure connection between adjacent link assemblies 102 while maintaining a smooth surface profile on the bowling ball support assembly 100.

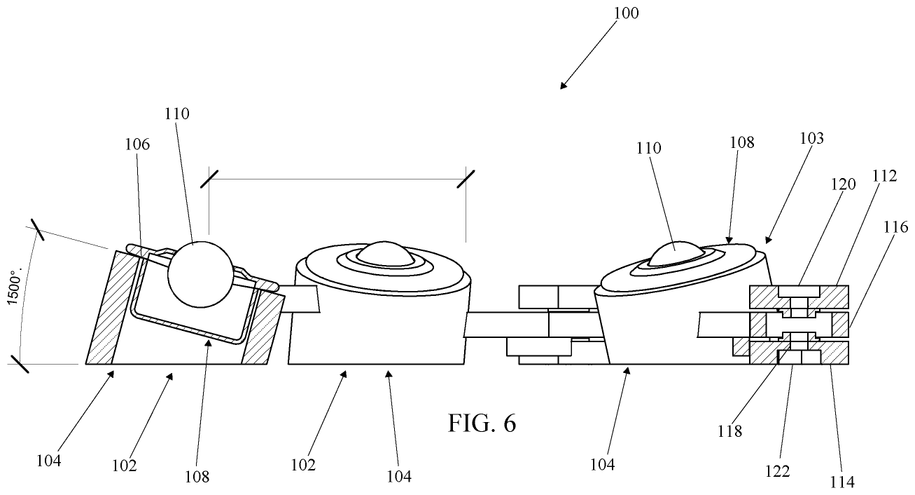

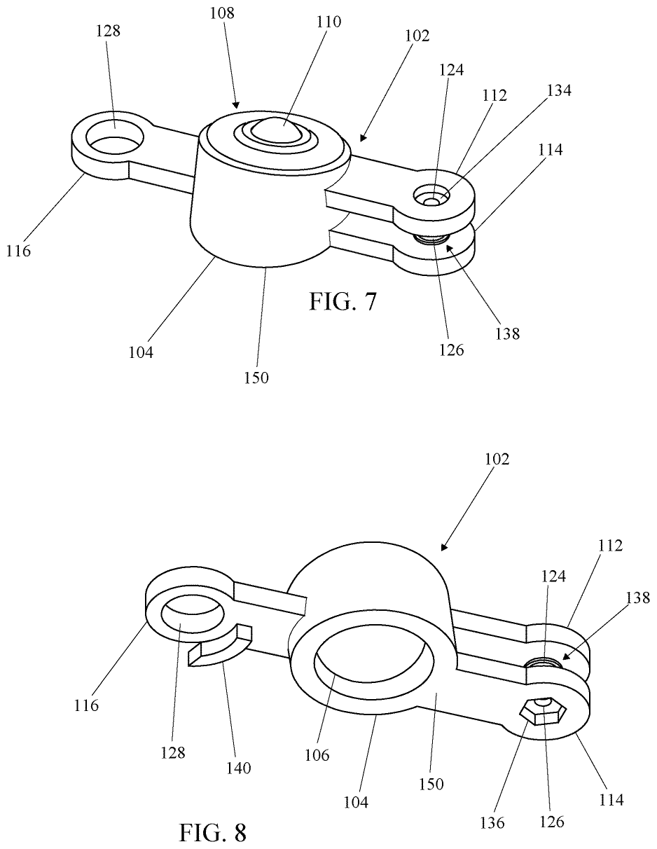

Referring to FIG. 7, a top exterior side perspective view of a link assembly 102 of the bowling ball support assembly 100 is shown. The link assembly 102 may include the roller ball bearing support platform 104 positioned centrally within the structure. The roller ball bearing assembly 108 may be coupled to the roller ball bearing support platform 104, with the ball 110 visible at a top of the roller ball bearing assembly 108. The ball 110 may be configured to rotate freely within the roller ball bearing assembly 108 to provide rotational support for a bowling ball placed thereon.

With continued reference to FIG. 7, the first outer connection member 112 and the second outer connection member 114 may extend laterally from one side of the roller ball bearing support platform 104. The first outer connection member 112 and the second outer connection member 114 may be positioned substantially in parallel to each other.

The first outer connection member 112 may comprise a first outer member hole 124 that forms an axis of rotation for connecting adjacent link assemblies 102. The second outer connection member 114 may comprise a second outer member hole 126 that aligns coaxially with the first outer member hole 124 to form a shaft extending through the first outer connection member 112 and the second outer connection member 114. The bearing pin 118 may extend through the first outer member hole 124 and the second outer member hole 126 to connect adjacent link assemblies 102.

As further shown in FIG. 7, a bearing pin head seat 134 may be formed on a top surface of the first outer connection member 112. The bearing pin head seat 134 may be configured to receive the bearing pin head 120 flush below the top surface of the first outer connection member 112. This configuration may allow the bearing pin head 120 to be recessed within the first outer connection member 112, providing a smooth surface profile on the bowling ball support assembly 100.

With continued reference to FIG. 7, the inner connection member 116 may extend from the roller ball bearing support platform 104 on an opposite side from the first outer connection member 112 and the second outer connection member 114. The inner connection member 116 may comprise an inner member roller seat 128 configured to receive a roller that is operably rotatable therewithin. The inner member roller seat 128 may provide a receptacle for a roller component that facilitates rotational movement between adjacent link assemblies 102. The roller ball bearing support platform 104 may include the bottom flat surface 150 that provides stability when the bowling ball support assembly 100 is placed on a supporting surface.

Referring to FIG. 8, a bottom interior side perspective view of a single link section of the bowling ball support assembly 100 is depicted. The link assembly 102 may include the roller ball bearing support platform 104 positioned centrally within the structure. The roller ball bearing support platform 104 may include the roller ball bearing assembly seat 106 configured to receive and retain the roller ball bearing assembly 108.

With continued reference to FIG. 8, the first outer connection member 112 and the second outer connection member 114 may extend laterally from one side of the roller ball bearing support platform 104. The first outer connection member 112 and the second outer connection member 114 may be positioned in parallel to each other. The first outer connection member 112 may comprise the first outer member hole 124 that forms an axis of rotation for connecting adjacent link assemblies 102. The second outer connection member 114 may comprise a second outer member hole 126 that aligns with the first outer member hole 124. The first outer member hole 124 and the second outer member hole 126 may together form an axis of rotation through which the bearing pin 118 extends to connect adjacent link assemblies 102.

As further shown in FIG. 8, an outer member roller seat 138 may be positioned between the first outer connection member 112 and the second outer connection member 114. The outer member roller seat 138 may be configured to accommodate a roller during rotation between adjacent link assemblies 102. The outer member roller seat 138 may work in conjunction with the inner member roller seat 128 of an adjacent link assembly 102 to provide smooth rotational movement between interconnected link assemblies 102.

With continued reference to FIG. 8, a bearing pin nut seat 136 may be formed on a bottom surface of the second outer connection member 114. The bearing pin nut seat 136 may be configured to receive the bearing pin nut 122 flush above the bottom surface of the second outer connection member 114. This configuration may allow the bearing pin nut 122 to be recessed within the second outer connection member 114, maintaining a smooth surface profile on the bowling ball support assembly 100. The bearing pin 118, with the bearing pin head 120 seated within the bearing pin head seat 134 and the bearing pin nut 122 seated within the bearing pin nut seat 136, may provide a secure connection between adjacent link assemblies 102 while allowing rotational movement therebetween.

As further shown in FIG. 8, the inner connection member 116 may extend from the roller ball bearing support platform 104 on an opposite side from the first outer connection member 112 and the second outer connection member 114. The inner connection member 116 may comprise the inner member roller seat 128 configured to receive a roller that is operably rotatable therewithin. The angled stop plates 140 may be positioned on the link assembly 102 to limit a range of motion between adjacent link assemblies 102 when the bowling ball support assembly 100 is configured in the radial arrangement. The link assembly 102 may include the bottom flat surface 150 that provides stability when the bowling ball support assembly 100 is placed on a supporting surface. The link assembly 102 may be formed by the bottom surfaces of the roller ball bearing support platform 104 and the second outer connection member 114.

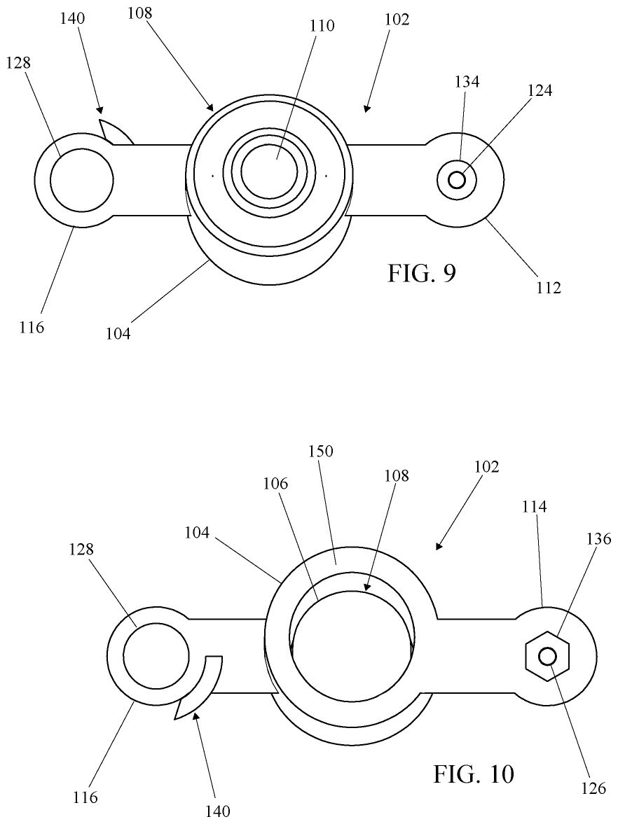

Referring to FIG. 9, a top plan view of the connecting link assembly 102 is shown. The link assembly 102 may include the roller ball bearing support platform 104 positioned centrally within the structure. The roller ball bearing assembly 108 may be coupled to the roller ball bearing support platform 104, with the ball 110 visible at a top of the roller ball bearing assembly 108. The ball 110 may be configured to rotate freely within the roller ball bearing assembly 108 to provide rotational support for a bowling ball placed thereon.

With continued reference to FIG. 9, the first outer connection member 112 may extend laterally from one side of the roller ball bearing support platform 104. The first outer connection member 112 may be positioned to extend in parallel with the second outer connection member 114 of the link assembly 102. The first outer connection member 112 may comprise the first outer member hole 124 that forms an axis of rotation for connecting adjacent link assemblies 102. The bearing pin head seat 134 may be formed on a top surface of the first outer connection member 112, configured to receive the bearing pin head 120 flush below the top surface.

As further shown in FIG. 9, the inner connection member 116 may extend from the roller ball bearing support platform 104 on an opposite side from the first outer connection member 112. The inner connection member 116 may comprise the inner member roller seat 128 configured to receive a roller that is operably rotatable therewithin. The angled stop plates 140 may be positioned on the link assembly 102 to limit a range of motion between adjacent link assemblies 102 when the bowling ball support assembly 100 is configured in the radial arrangement. The angled stop plates 140 may extend from the roller ball bearing support platform 104 at predetermined angles to engage with corresponding surfaces of adjacent link assemblies 102, thereby restricting angular displacement beyond a desired range.

Referring to FIG. 10, a bottom plan view of the connecting link assembly 102 is illustrated. The link assembly 102 may include the roller ball bearing support platform 104 positioned centrally within the structure. The roller ball bearing assembly seat 106 may be formed within the roller ball bearing support platform 104, configured to receive the roller ball bearing assembly 108. The roller ball bearing assembly seat 106 may be cylindrical in nature and may provide a depth sufficient to securely retain the roller ball bearing assembly 108.

With continued reference to FIG. 10, the second outer connection member 114 may extend laterally from one side of the roller ball bearing support platform 104. The inner connection member 116 may extend from the roller ball bearing support platform 104 on an opposite side from the second outer connection member 114. The inner connection member 116 may comprise the inner member roller seat 128, which may be configured to receive a roller that is operably rotatable therewithin. The second outer connection member 114 may comprise the second outer member hole 126, which may form an axis of rotation for connecting adjacent link assemblies 102.

As further shown in FIG. 10, the bearing pin nut seat 136 may be visible on a bottom surface of the second outer connection member 114. The bearing pin nut seat 136 may be configured to receive the bearing pin nut 122 flush above the bottom surface of the second outer connection member 114. The angled stop plates 140 may be positioned on the link assembly 102 to limit a range of motion between adjacent link assemblies 102 when connected. The link assembly 102 may include the bottom flat surface 150 that is formed between the bottom integral surfaces of roller ball bearing support platform 104 and the second outer connection member 114, which may provide stability when the bowling ball support assembly 100 is placed on a flat surface and may allow for nesting of multiple chain support assemblies 100 when arranged in their radial configurations.

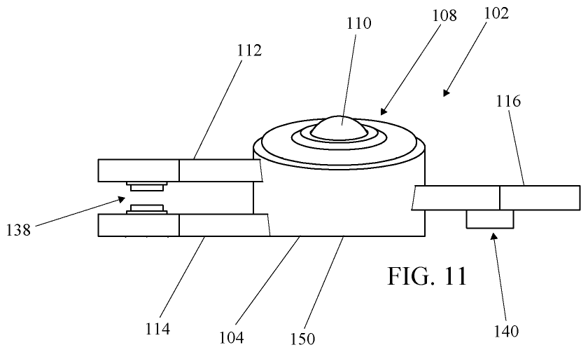

Referring to FIG. 11, an interior side elevation view of the connecting link assembly 102 is depicted. The link assembly 102 may include the roller ball bearing support platform 104 positioned centrally within the structure. The roller ball bearing assembly 108 may be coupled to the roller ball bearing support platform 104, with the ball 110 visible at a top of the roller ball bearing assembly 108. The ball 110 may be configured to rotate freely within the roller ball bearing assembly 108 to provide rotational support for a bowling ball placed thereon.

With continued reference to FIG. 11, the first outer connection member 112 may extend laterally from one side of the roller ball bearing support platform 104, and the second outer connection member 114 may be positioned in parallel to the first outer connection member 112. The outer member roller seat 138 may be positioned between the first outer connection member 112 and the second outer connection member 114. The outer member roller seat 138 may be configured to accommodate a roller during rotation between adjacent link assemblies 102.

As further shown in FIG. 11, the inner connection member 116 may extend from the roller ball bearing support platform 104 on an opposite side from the first outer connection member 112 and the second outer connection member 114. The angled stop plates 140 may be positioned on the link assembly 102 to limit a range of motion between adjacent link assemblies 102 when the bowling ball support assembly 100 is configured in the radial arrangement. The angled stop plates 140 may be oriented at angles corresponding to the desired angular limits of the pentagonal configuration, such that when adjacent link assemblies 102 are rotated relative to one another, the angled stop plates 140 contact corresponding surfaces to prevent further rotation beyond the predetermined range.

With continued reference to FIG. 11, the roller ball bearing support platform 104 and the second outer connection member 114 may combine to form the bottom flat surface 150, which provides stability when the bowling ball support assembly 100 is placed on a supporting surface. The relationship between the first outer connection member 112, the second outer connection member 114, and the inner connection member 116 may facilitate the chain-style interconnection of adjacent link assemblies 102. As described previously, the inner connection member 116 of one link assembly 102 may be configured to be positioned between the first outer connection member 112 and the second outer connection member 114 of an adjacent link assembly 102. A roller may be positioned between the first outer connection member 112 and the second outer connection member 114 of the adjacent link assembly 102 and may be rotatable within the inner member roller seat 128, providing smooth rotational movement between interconnected link assemblies 102

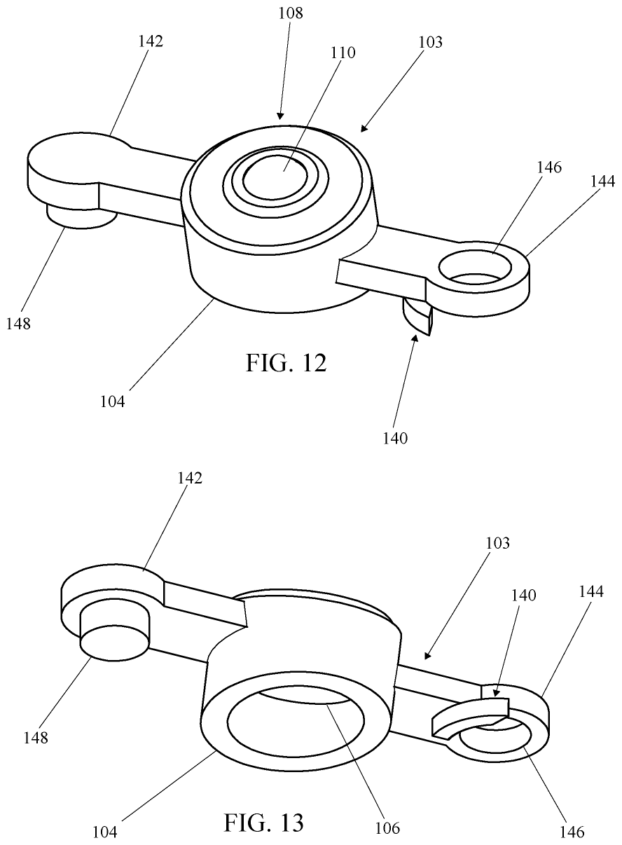

Referring to FIG. 12, an interior side top perspective view of the master link assembly 103 is shown. The master link assembly 103 may include the roller ball bearing support platform 104 positioned centrally within the master link assembly 103. The roller ball bearing assembly 108 may be coupled to the roller ball bearing support platform 104, with the ball 110 visible at a top of the roller ball bearing assembly 108. The ball 110 may be configured to rotate freely within the roller ball bearing assembly 108 to provide rotational support for a bowling ball placed thereon.

With continued reference to FIG. 12, a master link outer member 142 may extend laterally from one side of the roller ball bearing support platform 104. The master link outer member 142 may terminate in a rounded end portion. The master link mounting cylinder 148 may extend downward from the master link outer member 142. The master link mounting cylinder 148 may be configured to engage with the inner member roller seat 128 of an adjacent link assembly 102 to allow the bowling ball support assembly 100 to be opened and closed. This configuration may enable users to transition the bowling ball support assembly 100 between the radial configuration for supporting a bowling ball and the linear configuration for storage.

As further shown in FIG. 12, a master link inner connection member 144 may extend laterally from the roller ball bearing support platform 104 on an opposite side from the master link outer member 142. The master link inner connection member 144 may include a master link inner connection member roller seat 146 configured to receive a roller component that facilitates rotational movement between the master link assembly 103 and an adjacent link assembly 102. The master link inner connection member roller seat 146 may function similarly to the inner member roller seat 128 of the link assemblies 102, providing a receptacle for a roller that enables smooth pivoting motion between interconnected components.

With continued reference to FIG. 12, the angled stop plates 140 may be positioned on the master link assembly 103 between the roller ball bearing support platform 104 and the master link inner connection member 144. The angled stop plates 140 may serve to limit a range of motion between the master link assembly 103 and adjacent link assemblies 102 when the bowling ball support assembly 100 is configured in the radial arrangement. The master link inner connection member 144 may be configured to be positioned between the first outer connection member 112 and the second outer connection member 114 of an adjacent link assembly 102, similar to the inner connection member 116 of the link assemblies 102.

Referring to FIG. 13, an interior side bottom perspective view of the master link assembly 103 is presented. The master link assembly 103 may include the roller ball bearing support platform 104 positioned centrally within the structure. The roller ball bearing support platform 104 may include the roller ball bearing assembly seat 106 configured to receive and retain the roller ball bearing assembly 108.

With continued reference to FIG. 13, the master link outer member 142 may extend laterally from one side of the roller ball bearing support platform 104, terminating in the rounded end portion. The master link mounting cylinder 148 may extend downward from the master link outer member 142. The master link mounting cylinder 148 may be configured to engage with the inner member roller seat 128 of an adjacent link assembly 102. When the master link mounting cylinder 148 is inserted into the inner member roller seat 128 of an end link assembly 102, the bowling ball support assembly 100 may be closed to form the radial configuration. When the master link mounting cylinder 148 is disengaged from the inner member roller seat 128, the bowling ball support assembly 100 may be opened and reconfigured into the linear configuration for storage.

As further shown in FIG. 13, the angled stop plates 140 may be positioned on the master link assembly 103 between the roller ball bearing support platform 104 and the adjacent connection members. The angled stop plates 140 may serve to limit a range of motion between the master link assembly 103 and adjacent link assemblies 102, similar to the function of the angled stop plates 140 in other parts of the bowling ball support assembly 100. The master link inner connection member 144 may extend laterally from the roller ball bearing support platform 104 on an opposite side from the master link outer member 142. The master link inner connection member 144 may include the master link inner connection member roller seat 146 configured to receive a roller component that facilitates rotational movement between the master link assembly 103 and an adjacent link assembly 102.

The master link assembly 103 may be configured to allow the chain formation to be opened and closed. As described previously, the link assemblies 102 may be configurable between the radial configuration for supporting a bowling ball and the linear configuration for storage. The master link assembly 103 may provide the connection point that enables this transition. The plurality of interconnected link assemblies 102 may be arranged in a chain formation, with each link assembly 102 comprising the roller ball bearing support platform 104 configured to support the roller ball bearing assembly 108. The first outer connection member 112 and the second outer connection member 114 may extend laterally in parallel from the roller ball bearing support platform 104, and the inner connection member 116 may extend from the roller ball bearing support platform 104 opposite the first outer connection member 112 and the second outer connection member 114. The inner connection member 116 may be configured to be positioned between the first outer connection member 112 and the second outer connection member 114 of an adjacent link assembly 102. The roller ball bearing assembly 108 may be coupled to each roller ball bearing support platform 104.

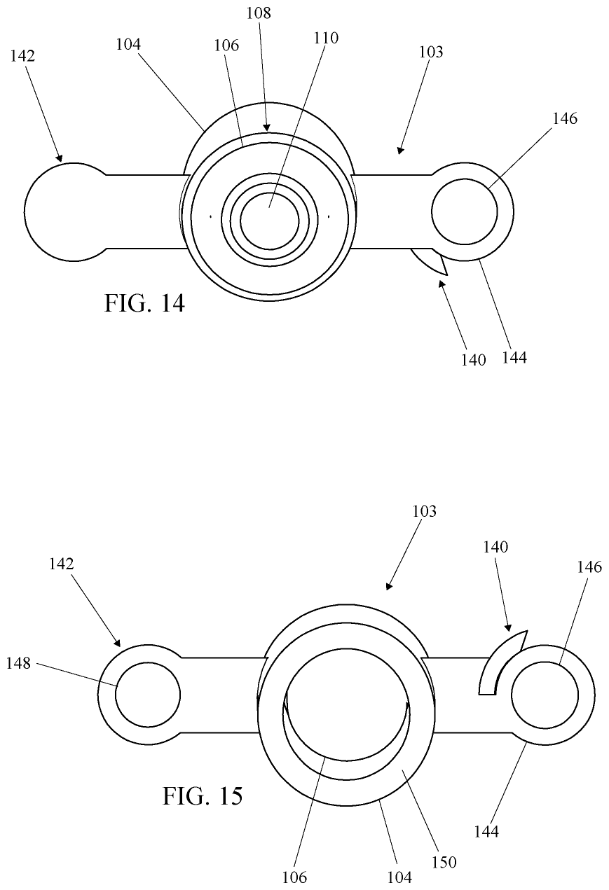

Referring to FIG. 14, a top plan view of the master link assembly 103 is illustrated. The master link assembly 103 may include the roller ball bearing support platform 104 positioned centrally within the master link assembly 103. The roller ball bearing assembly 108 may be coupled to the roller ball bearing support platform 104, with the ball 110 visible at a top of the roller ball bearing assembly 108. The ball 110 may be configured to rotate freely within the roller ball bearing assembly 108 to provide rotational support for a bowling ball placed thereon. The roller ball bearing support platform 104 may include the roller ball bearing assembly seat 106 configured to receive and retain the roller ball bearing assembly 108 in a secure manner.

With continued reference to FIG. 14, the master link outer member 142 may extend laterally from one side of the roller ball bearing support platform 104, terminating in a rounded end portion. On an opposite side of the roller ball bearing support platform 104, the master link inner connection member 144 may extend laterally and may include the master link inner connection member roller seat 146. The master link inner connection member roller seat 146 may be configured to receive a roller component that facilitates rotational movement between the master link assembly 103 and an adjacent link assembly 102. As described previously, the inner connection member 116 of each link assembly 102 may comprise an inner member roller seat 128 configured to receive a roller that is operably rotatable therewithin. The master link inner connection member roller seat 146 may function in a similar manner to the inner member roller seat 128, providing a receptacle for a roller that enables smooth pivoting motion between interconnected components.

As further shown in FIG. 14, the angled stop plates 140 may be positioned on the master link assembly 103 between the roller ball bearing support platform 104 and the master link inner connection member 144. The angled stop plates 140 may serve to limit a range of motion between the master link assembly 103 and adjacent link assemblies 102 when the bowling ball support assembly 100 is configured in the radial arrangement. The angled stop plates 140 may extend at predetermined angles to engage with corresponding surfaces of adjacent link assemblies 102, thereby restricting angular displacement beyond a desired range.

Referring to FIG. 15, a bottom plan view of the master link assembly 103 is presented. The master link assembly 103 may include the roller ball bearing support platform 104 positioned centrally within the master link assembly 103. The roller ball bearing support platform 104 may feature the roller ball bearing assembly seat 106 configured to receive and support the roller ball bearing assembly 108. The roller ball bearing assembly seat 106 may be visible from the bottom plan view as a circular recess within the roller ball bearing support platform 104.

With continued reference to FIG. 15, the master link outer member 142 may extend laterally from one side of the roller ball bearing support platform 104. The master link mounting cylinder 148 may extend from below the master link outer member 142. The master link mounting cylinder 148 may be configured to engage with the inner member roller seat 128 of an adjacent link assembly 102 to allow the bowling ball support assembly 100 to be opened and closed. The master link inner connection member 144 may extend from an opposite side of the roller ball bearing support platform 104 and may include the master link inner connection member roller seat 146 configured to receive a roller component.

As further shown in FIG. 15, the angled stop plates 140 may be positioned on the master link assembly 103 to limit a range of motion between the master link assembly 103 and adjacent link assemblies 102. The roller ball bearing support platform 104 may include the bottom flat surface 150. The bottom flat surface 150 may provide stability when the master link assembly 103 is placed on a flat surface.

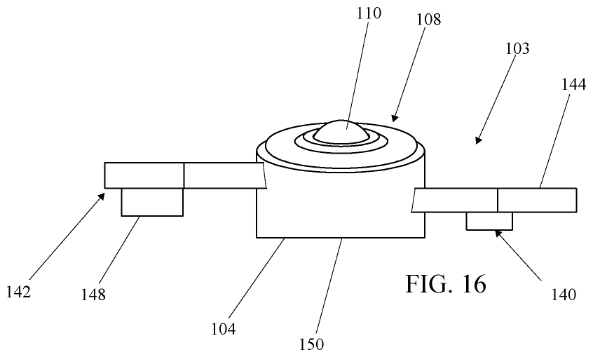

Referring to FIG. 16, an interior elevation view of the master link assembly 103 is depicted. The master link assembly 103 may include the roller ball bearing support platform 104 positioned centrally within the master link assembly 103. The roller ball bearing assembly 108 may be coupled to the roller ball bearing support platform 104, with the ball 110 visible at a top of the roller ball bearing assembly 108. The ball 110 may be configured to rotate freely within the roller ball bearing assembly 108 to provide rotational support for a bowling ball placed thereon.

With continued reference to FIG. 16, the master link outer member 142 may extend laterally from one side of the roller ball bearing support platform 104, while the master link inner connection member 144 may extend laterally from an opposite side of the roller ball bearing support platform 104. The angled stop plates 140 may be positioned below the master link inner connection member 144, serving to limit a range of motion between the master link assembly 103 and adjacent link assemblies 102 when the bowling ball support assembly 100 is configured in the radial arrangement.

As further shown in FIG. 16, the master link mounting cylinder 148 may extend downward from the master link outer member 142. The master link mounting cylinder 148 may be configured to engage with the inner member roller seat 128 of an adjacent link assembly 102 to a llow the bowling ball support assembly 100 to be opened and closed. The roller ball bearing support platform 104 may include the bottom flat surface 150 that provides stability when the master link assembly 103 is placed on a flat surface. The interior elevation view of FIG. 16 reveals the vertical profile of the master link assembly 103, showing how the roller ball bearing assembly 108 with the ball 110 is elevated above the bottom flat surface 150 to properly engage with and support a bowling ball during cleaning or maintenance operations.

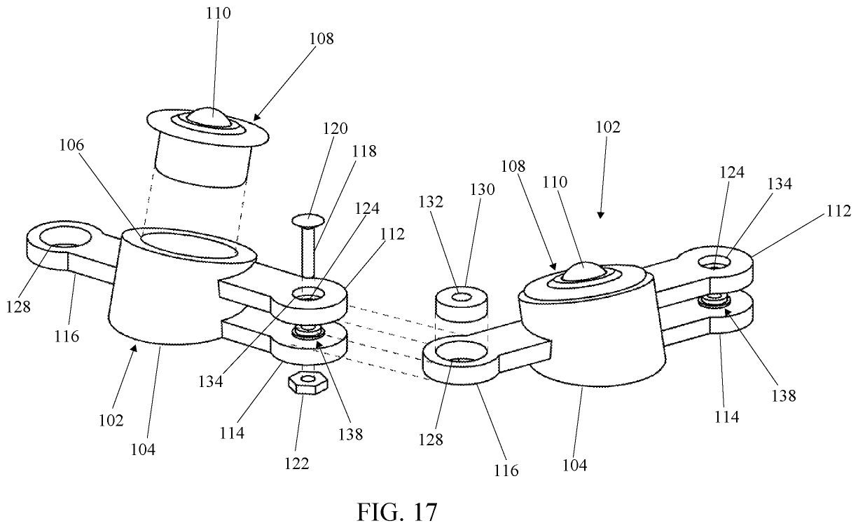

Referring to FIG. 17, an exploded isometric view of the link assembly 102 is shown on a left side and a partially assembled isometric view of the link assembly 102 is shown on a right side. The exploded view depicts individual components and spatial relationships thereof prior to assembly. The link assembly 102 may include the roller ball bearing support platform 104 positioned centrally within the structure. The roller ball bearing support platform 104 may feature the roller ball bearing assembly seat 106 configured to receive and retain the roller ball bearing assembly 108. The roller ball bearing assembly 108 may contain the ball 110 that is configured to rotate freely to provide rotational support for a bowling ball placed thereon.

With continued reference to FIG. 17, the first outer connection member 112 may extend laterally from one side of the roller ball bearing support platform 104, while the second outer connection member 114 may be positioned in parallel to the first outer connection member 112. The first outer connection member 112 may comprise the first outer member hole 124 that forms an axis of rotation for connecting adjacent link assemblies 102. The bearing pin head seat 134 may be formed on a top surface of the first outer connection member 112, configured to receive the bearing pin head 120 flush below the top surface. The second outer connection member 114 may comprise the second outer member hole 126 that aligns with the first outer member hole 124.

As further shown in FIG. 17, the bearing pin 118 may extend through the first outer member hole 124 and the second outer member hole 126 to connect adjacent link assemblies 102. The bearing pin 118 may include the bearing pin head 120 at one end and the bearing pin nut 122 at an opposite end. The bearing pin head 120 may be configured to seat within the bearing pin head seat 134 flush below the top surface of the first outer connection member 112. The bearing pin nut 122 may be configured to seat within the bearing pin nut seat 136 flush above a bottom surface of the second outer connection member 114. This configuration may allow the bearing pin 118 to be secured within the link assembly 102 while maintaining a smooth surface profile on the bowling ball support assembly 100.

With continued reference to FIG. 17, the outer member roller seat 138 of the link assemblies 102 may be positioned between the first outer connection member 112 and the second outer connection member 114. A roller 130 may be configured to be received within the outer member roller seats 138. The roller 130 may include a hole 132 extending therethrough. The hole 132 may be configured to receive the bearing pin 118 therethrough. The roller 130 may be positioned between the first outer connection member 112 and the second outer connection member 114 of an adjacent link assembly 102 and may be rotatable within the inner member roller seat 128 to provide an axis of rotation between adjacent link assemblies 102. The roller 130 may facilitate smooth rotational movement between interconnected link assemblies by rotating within both the outer member roller seat 138 and the inner member roller seat 128.

As further shown in FIG. 17, the inner connection member 116 may extend from the roller ball bearing support platform 104 on an opposite side from the first outer connection member 112 and the second outer connection member 114. The inner connection member 116 may comprise the inner member roller seat 128, configured to receive the roller 130, which is operably rotatable therewithin. When adjacent link assemblies 102 are connected, the inner connection member 116 of one link assembly 102 may be positioned between the first outer connection member 112 and the second outer connection member 114 of an adjacent link assembly 102. The roller 130 may be positioned within the inner member roller seat 128 of the inner connection member 116 and within the outer member roller seat 138 between the first outer connection member 112 and the second outer connection member 114 of the adjacent link assembly 102. The bearing pin 118 may extend through the hole 132 of the roller 130 and through the first outer member hole 124 and the second outer member hole 126 to secure the connection between adjacent link assemblies 102.

With continued reference to FIG. 17, the partially assembled view on the right side shows the link assembly 102 with some components in assembled positions, demonstrating how the components interconnect to form articulating joints between adjacent link assemblies 102 in the bowling ball support assembly 100. As described previously, angled stop plates 140 may be positioned between adjacent link assemblies 102 to limit a range of motion between the adjacent link assemblies 102. The angled stop plates 140 may restrict angular displacement between interconnected link assemblies 102 to maintain the desired pentagonal configuration when the bowling ball support assembly 100 is arranged in the radial configuration for supporting a bowling ball.

As further shown in FIG. 17, the assembly sequence may involve positioning the roller 130 within the outer member roller seat 138 between the first outer connection member 112 and the second outer connection member 114, with the inner connection member 116 of an adjacent link assembly 102 positioned such that the inner member roller seat 128 receives the roller 130. The bearing pin 118 may then be inserted through the first outer member hole 124, through the hole 132 of the roller 130, and through the second outer member hole 126. The bearing pin head 120 may seat within the bearing pin head seat 134 on the top surface of the first outer connection member 112, and the bearing pin nut 122 may seat within the bearing pin nut seat 136 on the bottom surface of the second outer connection member 114. As described previously, the master link assembly 103 may comprise the master link outer member 142 and the master link mounting cylinder 148 extending from the master link outer member 142, wherein the master link mounting cylinder 148 may be configured to engage with the inner member roller seat 128 of an adjacent link assembly 102 to allow the bowling ball support assembly 100 to be opened and closed.

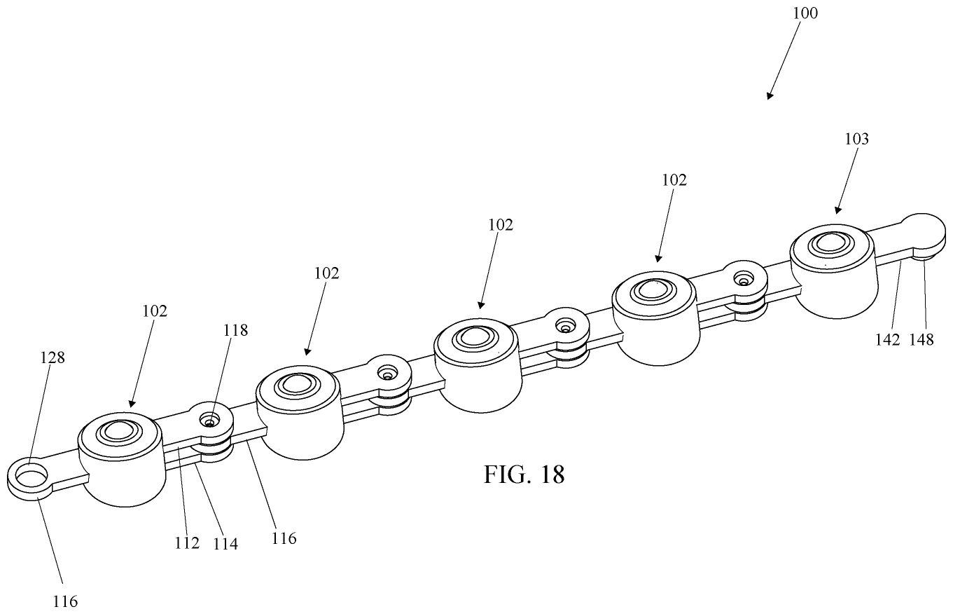

Referring to FIG. 18, a top perspective view of the bowling ball support assembly 100 in an extended linear configuration is illustrated. The bowling ball support assembly 100 may comprise the plurality of interconnected link assemblies 102 arranged in a sequential chain formation. Each link assembly 102 may include the inner connection member 116 extending from one side of the roller ball bearing support platform 104. The inner connection member 116 may feature the inner member roller seat 128 configured to receive a roller rotatable therewithin and to facilitate rotational connection between adjacent link assemblies 102. Adjacent link assemblies 102 may be connected via the bearing pins 118, which may extend through the outer member holes of the first outer connection member 112 and the second outer connection member 114 to connect adjacent link assemblies 102 and provide an axis of rotation. Each link assembly 102 may include the first outer connection member 112 and the second outer connection member 114 extending laterally in parallel from the roller ball bearing support platform 104, each of which may pinch the inner connection member 116 of the adjacent link assembly 102.

With continued reference to FIG. 18, the master link assembly 103 may be positioned at one end of the bowling ball support assembly 100. The master link assembly 103 may include the master link outer member 142 extending laterally. The master link mounting cylinder 148 may extend from the master link outer member 142. The master link mounting cylinder 148 may be configured to engage with the inner member roller seat 128 of an adjacent link assembly 102 to allow the support assembly to be opened and closed. In the extended linear configuration shown in FIG. 18, the master link mounting cylinder 148 may be disengaged from the inner member roller seat 128 of the end link assembly 102, allowing the bowling ball support assembly 100 to be opened and arranged in the sequential chain formation for storage or transport. This linear configuration demonstrates how the bowling ball support assembly 100 may be reconfigured from the radial arrangement into an extended linear arrangement for storage.

As further shown in FIG. 18, the roller ball bearing assembly seat 106 of each link assembly 102 may be visible in the top perspective view. As described previously, the roller ball bearing assembly 108 may be coupled to each roller ball bearing support platform 104, and when the link assemblies 102 are arranged in the pentagonal configuration, the roller ball bearing assemblies 108 may be arranged in an inwardly angled radial pattern to support a bowling ball in a rotational manner. In the extended linear configuration, the link assemblies 102 may be arranged in the sequential chain formation, with each link assembly 102 connected to adjacent link assemblies 102 through the bearing pins 118 extending through the outer member holes forming an axis of rotation.

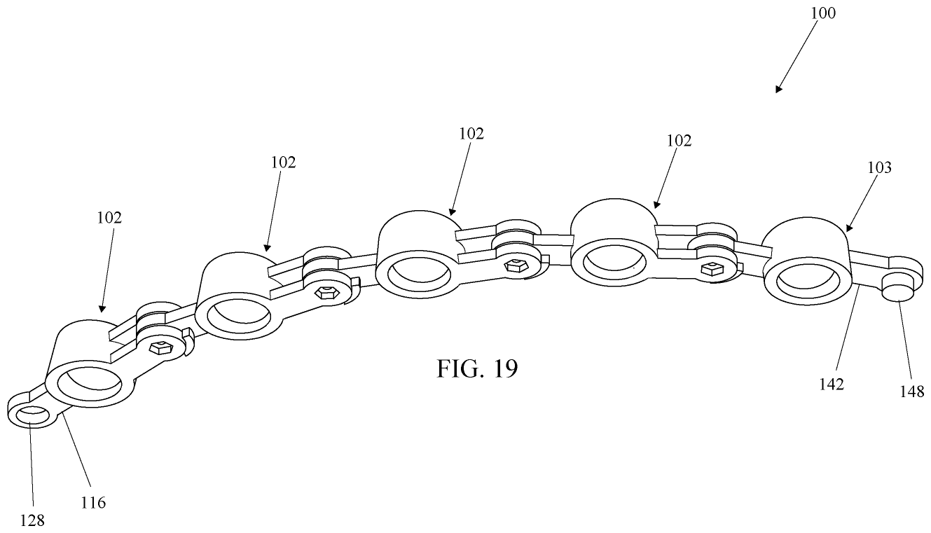

Referring to FIG. 19, a bottom isometric view of the bowling ball support assembly 100 in an extended linear configuration is depicted, shown in an open or not assembled state. The bowling ball support assembly 100 may comprise the plurality of interconnected link assemblies 102 arranged in a sequential chain formation suitable for storage or transport. Each link assembly 102 may include the inner connection member 116 extending from one side of the roller ball bearing support platform 104. The inner connection member 116 may feature the inner member roller seat 128 configured to receive a roller component and facilitate rotational connection between adjacent link assemblies 102.

With continued reference to FIG. 19, the bowling ball support assembly 100 is shown in a curved linear arrangement, demonstrating the flexibility of the interconnected link assemblies 102 when not configured in the radial arrangement for supporting a bowling ball. The master link assembly 103 master link outer member 142 may be visible at one end of the bowling ball support assembly 100, extending laterally from the master link assembly 103. The master link mounting cylinder 148 may extend from the master link outer member 142. The master link mounting cylinder 148 may be configured to engage with the inner member roller seat 128 of an adjacent link assembly 102 to allow the support assembly to be opened and closed.

As further shown in FIG. 19, when the master link mounting cylinder 148 is disengaged from the inner member roller seat 128 of the end link assembly 102, the bowling ball support assembly 100 may be opened and reconfigured from the pentagonal configuration into the extended linear configuration. To transition the bowling ball support assembly 100 from the linear configuration to the radial configuration, a user may align the master link mounting cylinder 148 with the inner member roller seat 128 of the end link assembly 102 and insert the master link mounting cylinder 148 into the inner member roller seat 128. This engagement may close the bowling ball support assembly 100 into the pentagonal configuration where the roller ball bearing assemblies 108 are arranged in the inwardly angled radial pattern to support a bowling ball in a rotational manner. To transition from the radial configuration to the linear configuration, the user may disengage the master link mounting cylinder 148 from the inner member roller seat 128, allowing the chain of link assemblies 102 to be opened and arranged in the sequential chain formation for storage.

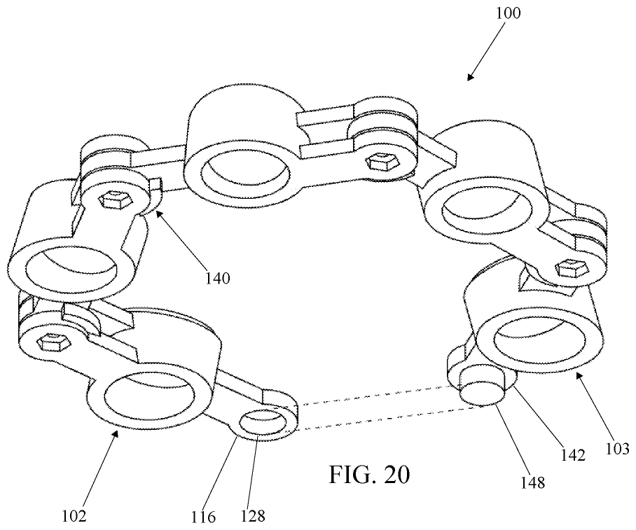

With reference to FIG. 20, to deploy the bowling ball support assembly 100 from the flexible linear configuration to the radial configuration, a user may first lay the chain of interconnected link assemblies 102 on a flat supporting surface. The user may then manipulate the link assemblies 102 by pivoting adjacent link assemblies 102 relative to one another about the bearing pins 118 to arrange the link assemblies 102 into the desired radial pattern, such as the pentagonal configuration. As the link assemblies 102 are pivoted into position, the angled stop plates 140 may contact corresponding surfaces of adjacent link assemblies 102 to indicate when the proper angular position has been reached. Once the link assemblies 102 are arranged in the radial pattern with the master link assembly 103 positioned adjacent to the end link assembly 102, the user may grasp the master link assembly 103 and align the master link mounting cylinder 148 with the inner member roller seat 128 of the end link assembly 102. The user may then press the master link mounting cylinder 148 downward into the inner member roller seat 128 until the master link mounting cylinder 148 is fully seated within the inner member roller seat 128. A tactile click or resistance may indicate that the master link mounting cylinder 148 has been properly engaged with the inner member roller seat 128, securing the bowling ball support assembly 100 in the radial configuration. The deployed bowling ball support assembly 100 may then be ready to receive a bowling ball 300 for cleaning, polishing, or maintenance operations.

With continued reference to FIG. 19, as described previously, each link assembly 102 may comprise the roller ball bearing support platform 104 having the bottom flat surface 150. The first outer connection member 112 and the second outer connection member 114 may be positioned in parallel and may extend laterally from the roller ball bearing support platform 104. Each of the first outer connection member 112 and the second outer connection member 114 may comprise an outer member hole forming an axis of rotation. The inner connection member 116 may extend from the roller ball bearing support platform 104 opposite the first outer connection member 112 and the second outer connection member 114. The bearing pin 118 may extend through the outer member holes to connect adjacent link assemblies 102. As described previously, angled stop plates 140 may be positioned between adjacent link assemblies 102 to limit a range of motion between the adjacent link assemblies 102, helping to maintain the desired pentagonal configuration when the bowling ball support assembly 100 is closed and arranged in the radial configuration for supporting a bowling ball.

Referring to FIG. 20, a bottom perspective view of the bowling ball support assembly 100 configured in a radial arrangement for supporting a bowling ball is illustrated, shown in an unassembled or chain-open configuration. The bowling ball support assembly 100 may comprise the plurality of interconnected link assemblies 102 and the master link assembly 103 arranged in the pentagonal configuration. In this chain-open radial arrangement, the link assemblies 102 may be positioned in the pentagonal configuration, but the master link assembly 103 may be disengaged from the end link assembly 102, such that the master link mounting cylinder 148 is not inserted into the inner member roller seat 128 of the end link assembly 102.

With continued reference to FIG. 20, each link assembly 102 may include the inner connection member 116 extending from one side of the roller ball bearing support platform 104. The inner connection member 116 may feature the inner member roller seat 128 configured to receive a roller component and facilitate rotational connection between adjacent link assemblies 102. The inner connection members 116 of the link assemblies 102 may be visible in the bottom perspective view, with each inner connection member 116 positioned between the first outer connection member 112 and the second outer connection member 114 of an adjacent link assembly 102.

As further shown in FIG. 20, the angled stop plates 140 may be positioned between adjacent link assemblies 102. The angled stop plates 140 may limit a range of motion between the interconnected link assemblies 102, helping to maintain the desired pentagonal configuration when supporting a bowling ball. The angled stop plates 140 may be visible in the bottom perspective view, extending from the roller ball bearing support platforms 104 at predetermined angles to engage with corresponding surfaces of adjacent link assemblies 102.

With continued reference to FIG. 20, the master link assembly 103 may be positioned within the pentagonal arrangement and may include the master link outer member 142 extending laterally from one side. The master link mounting cylinder 148 may extend from the master link outer member 142. In the chain-open configuration shown, the master link mounting cylinder 148 may be positioned adjacent to but not engaged with the inner member roller seat 128 of the end link assembly 102, demonstrating how the bowling ball support assembly 100 may be opened and closed to enable transition between the radial configuration and the linear configuration for storage.

Referring to FIG. 1 and FIG. 21, an isometric view of the bowling ball support assembly 100 configured in the radial arrangement with the bowling ball 300 positioned thereon is illustrated. The bowling ball 300 may be a spherical object featuring three finger holes visible on a surface thereof. The bowling ball 300 may rest upon the bowling ball support assembly 100, which may comprise the plurality of interconnected link assemblies 102 arranged in the pentagonal configuration beneath the bowling ball 300.

With continued reference to FIG. 21, each link assembly 102 may include the roller ball bearing assembly containing the ball 110 that contacts an underside of the bowling ball 300. The balls 110 may be positioned in an inwardly angled radial pattern to provide rotational support for the bowling ball 300. The bowling ball 300 may be rotated freely during cleaning or maintenance operations due to the rotational capability of the balls 110 within the roller ball bearing assemblies. The bowling ball support assembly 100 may cradle the bowling ball 300 with the roller ball bearing assemblies distributed around a perimeter of the pentagonal arrangement, maintaining contact with the bowling ball 300 at multiple points to provide stable support while permitting smooth rotation of the bowling ball 300 in any direction. When the bowling ball 300 is placed on the bowling ball support assembly 100, the downward force exerted by the weight of the bowling ball 300 may force the roller ball bearing assemblies to equilibrium, with the equal spacing of the roller ball bearing assemblies helping to keep the bowling ball 300 in balance.

As further shown in FIG. 21, the pentagonal configuration of the link assemblies 102 may distribute the weight of the bowling ball 300 across the plurality of link assemblies 102. The bottom flat surface 150 of each roller ball bearing support platform 104 may provide a stable base when the bowling ball support assembly 100 is placed on a supporting surface. The inwardly angled orientation of the roller ball bearing assemblies may help to cradle and center the bowling ball 300 on the bowling ball support assembly 100, preventing the bowling ball 300 from rolling off the bowling ball support assembly 100 during cleaning or maintenance operations.

With continued reference to FIG. 21, as described previously, the roller 130 of each inner connection member 116 may be configured to rotate within the inner member roller seat 128 while the bearing pin 118 extending through the outer member holes provides a separate axis of rotation. This configuration may result in adjacent link assemblies 102 being articulable relative to one another about two independent rotational axes to facilitate transitioning between the pentagonal configuration and the linear configuration. The two independent rotational axes may provide the bowling ball support assembly 100 with the flexibility to transition between the radial configuration shown in FIG. 21 for supporting the bowling ball 300 and the linear configuration for storage, while maintaining secure connections between adjacent link assemblies 102.

The chain support assembly may be configured with a different number of link assemblies to accommodate various bowling ball sizes or user preferences. In some cases, the link assemblies may be arranged in a square configuration with four link assemblies instead of the pentagonal configuration. The square configuration may form a four-sided radial arrangement where the roller ball bearing assemblies are positioned at four equally spaced locations around a perimeter of the square arrangement. The four link assemblies in the square configuration may be interconnected in the same chain-style manner as described previously, with the inner connection member of one link assembly positioned between the first outer connection member and the second outer connection member of an adjacent link assembly. The master link assembly may be configured to allow the square configuration to be opened and closed in a similar manner to the pentagonal configuration.

In some cases, the link assemblies may be arranged in a hexagonal configuration with six link assemblies instead of the pentagonal configuration. The hexagonal configuration may form a six-sided radial arrangement where the roller ball bearing assemblies are positioned at six equally spaced locations around a perimeter of the hexagonal arrangement. The six link assemblies in the hexagonal configuration may provide additional contact points for supporting a bowling ball, which may distribute the weight of the bowling ball across a greater number of roller ball bearing assemblies. The hexagonal configuration may be interconnected using the same bearing pin and roller connection mechanisms as described previously, with the master link assembly configured to allow the hexagonal configuration to be opened and closed for transitioning between the radial configuration and the linear configuration for storage.

The materials used in the construction of the chain support assembly may vary depending on factors such as weight considerations, cost, and intended usage environment. In some cases, the link assemblies, roller ball bearing support platforms, and other components may be fabricated from durable plastics such as high-density polyethylene (HDPE). High-density polyethylene may provide a lightweight construction while offering resistance to impact and wear during repeated use.

In some cases, the link assemblies, roller ball bearing support platforms, and other components may be fabricated from acrylonitrile butadiene styrene (ABS). Acrylonitrile butadiene styrene may provide a rigid construction with good impact resistance and dimensional stability. Components fabricated from acrylonitrile butadiene styrene may be suitable for injection molding processes, which may facilitate manufacturing of the link assemblies and other components of the chain support assembly.

In some cases, the link assemblies, roller ball bearing support platforms, and other components may be fabricated from metal alloys like aluminum. Aluminum may provide a lightweight yet durable construction for the chain support assembly. Components fabricated from aluminum may offer increased strength compared to plastic components while maintaining a relatively low weight for portability.

In some cases, the link assemblies, roller ball bearing support platforms, and other components may be fabricated from stainless steel for increased strength and durability. Stainless steel may provide corrosion resistance and may be suitable for use in environments where the chain support assembly may be exposed to moisture or cleaning agents during bowling ball maintenance operations. Components fabricated from stainless steel may offer increased load-bearing capacity compared to plastic or aluminum components.

In some cases, the roller ball bearing assemblies may incorporate roller bearings instead of ball bearings. Roller bearings may include cylindrical rolling elements that contact a bowling ball along a line rather than at a point. The cylindrical rolling elements of roller bearings may distribute the weight of the bowling ball across a larger contact area compared to ball bearings, which may affect the load distribution characteristics of the chain support assembly. Roller bearings may provide different rotational characteristics compared to ball bearings, and the selection between roller bearings and ball bearings may depend on user preferences or specific application requirements.

In some cases, the roller ball bearing assemblies may incorporate needle bearings instead of ball bearings. Needle bearings may include elongated cylindrical rolling elements with a length substantially greater than a diameter thereof. The elongated cylindrical rolling elements of needle bearings may provide a compact bearing configuration with a reduced radial profile compared to ball bearings or roller bearings. Needle bearings may be suitable for applications where space constraints within the roller ball bearing support platform favor a bearing assembly with reduced height. The selection of needle bearings may affect the overall weight capacity and rotational smoothness of the chain support assembly.

In some cases, the connection mechanism between link assemblies may employ snap-fit connections instead of bearing pins. Snap-fit connections may include resilient projections configured to deflect during assembly and engage with corresponding recesses or undercuts to retain adjacent link assemblies in a connected state. Snap-fit connections may allow for tool-free assembly and disassembly of the chain support assembly, which may simplify the process of transitioning between the radial configuration and the linear configuration. The resilient projections of snap-fit connections may be integrally formed with the outer connection members or inner connection members of the link assemblies.

In some cases, the connection mechanism between link assemblies may employ magnetic couplings instead of bearing pins. Magnetic couplings may include magnets positioned within the outer connection members and inner connection members of adjacent link assemblies. The magnets may be oriented such that attractive magnetic forces retain adjacent link assemblies in a connected state while permitting rotational movement therebetween. Magnetic couplings may allow for rapid assembly and disassembly of the chain support assembly without requiring physical engagement of mechanical fasteners. The strength of the magnetic couplings may be selected to provide sufficient retention force to maintain the radial configuration when supporting a bowling ball while permitting separation of the link assemblies when transitioning to the linear configuration.

In some cases, the connection mechanism between link assemblies may employ interlocking tabs instead of bearing pins. Interlocking tabs may include projections extending from one link assembly that engage with corresponding slots or recesses in an adjacent link assembly. The interlocking tabs may be configured to permit rotational movement between adjacent link assemblies while preventing separation thereof in directions perpendicular to an axis of rotation. Interlocking tabs may be integrally formed with the outer connection members or inner connection members of the link assemblies, which may reduce the number of separate components in the chain support assembly. The geometry of the interlocking tabs and corresponding slots may be configured to provide a desired range of rotational motion between adjacent link assemblies, similar to the function of the angled stop plates described previously.

In some cases, non-slip pads may be added to bottom surfaces of the link assemblies to enhance stability on various surfaces. The non-slip pads may be fabricated from elastomeric materials such as rubber or silicone that provide frictional engagement with a supporting surface. The non-slip pads may be adhered to the bottom flat surfaces of the roller ball bearing support platforms or may be mechanically attached thereto using fasteners or snap-fit connections. The non-slip pads may prevent the chain support assembly from sliding or shifting on smooth surfaces such as polished countertops, laminate tables, or tile floors during bowling ball cleaning or maintenance operations. The non-slip pads may be configured with textured surfaces or patterns that increase the coefficient of friction between the chain support assembly and the supporting surface. In some cases, the non-slip pads may be removable to allow for replacement when worn or to accommodate user preferences for different pad materials or thicknesses.

In some cases, adjustable feet may be included on the link assemblies to allow for leveling on uneven surfaces. The adjustable feet may be threaded members that engage with corresponding threaded receptacles formed in the bottom surfaces of the roller ball bearing support platforms. Rotation of the adjustable feet may extend or retract the adjustable feet relative to the roller ball bearing support platforms, thereby adjusting a height of each link assembly independently. The adjustable feet may allow a user to compensate for irregularities in a supporting surface by extending or retracting individual adjustable feet until the chain support assembly is level. The adjustable feet may include enlarged base portions that contact the supporting surface, and the enlarged base portions may be fabricated from non-slip materials to provide both leveling capability and enhanced stability. In some cases, the adjustable feet may be retractable to a position flush with or recessed within the bottom flat surfaces of the roller ball bearing support platforms when leveling adjustment is not required, which may facilitate compact storage of the chain support assembly in the linear configuration.

In some cases, the master link assembly may include a spring-loaded latch as a locking mechanism instead of the master link mounting cylinder described previously. The spring-loaded latch may comprise a latch member biased by a spring element toward an engaged position. The latch member may be configured to engage with a corresponding receptacle or catch formed on an adjacent link assembly when the chain support assembly is closed into the radial configuration. The spring element may urge the latch member into engagement with the corresponding receptacle, retaining the master link assembly in a connected state with the adjacent link assembly. To disengage the spring-loaded latch, a user may depress or actuate the latch member against the bias of the spring element, thereby releasing the latch member from the corresponding receptacle and allowing the chain support assembly to be opened for transition to the linear configuration. The spring-loaded latch may provide a secure connection that resists inadvertent opening of the chain support assembly during use while permitting intentional disengagement when desired.

In some cases, the master link assembly may include a twist-lock mechanism as a locking mechanism instead of the master link mounting cylinder described previously. The twist-lock mechanism may comprise a rotatable member configured to engage with a corresponding feature on an adjacent link assembly through rotational movement. The rotatable member may include projections or tabs that align with corresponding slots or recesses in the adjacent link assembly when the master link assembly is positioned adjacent thereto. Rotation of the rotatable member may cause the projections or tabs to move into an engaged position where the projections or tabs are retained behind corresponding surfaces of the adjacent link assembly, thereby locking the master link assembly to the adjacent link assembly. To disengage the twist-lock mechanism, a user may rotate the rotatable member in an opposite direction to move the projections or tabs out of engagement with the corresponding surfaces, allowing the chain support assembly to be opened for transition to the linear configuration. The twist-lock mechanism may provide a positive locking engagement that may be resistant to vibration or movement during bowling ball cleaning or maintenance operations.

In some cases, the master link assembly may include a sliding bolt system as a locking mechanism instead of the master link mounting cylinder described previously. The sliding bolt system may comprise a bolt member configured to translate linearly between an extended position and a retracted position. In the extended position, the bolt member may project from the master link assembly and engage with a corresponding receptacle or aperture formed in an adjacent end link assembly, thereby retaining the master link assembly in a connected state with the adjacent link assembly. In the retracted position, the bolt member may be withdrawn from engagement with the corresponding receptacle or aperture, allowing the chain support assembly to be opened for transition to the linear configuration. The sliding bolt system may include a handle, knob, or actuator that a user may grasp and manipulate to translate the bolt member between the extended position and the retracted position. In some cases, the sliding bolt system may include a detent or retention feature that maintains the bolt member in the extended position or the retracted position until intentionally actuated by a user, which may prevent inadvertent movement of the bolt member during use of the chain support assembly.

The bowling ball support assembly may be designed with modular components that allow users to add or remove link assemblies. In some cases, the connection mechanism between adjacent link assemblies may be configured to permit selective addition or removal of individual link assemblies from the chain formation. A user may add one or more link assemblies to the chain formation to increase the number of roller ball bearing assemblies supporting a bowling ball, which may distribute the weight of the bowling ball across a greater number of contact points. Conversely, a user may remove one or more link assemblies from the chain formation to reduce the overall size of the bowling ball support assembly or to accommodate smaller bowling balls. The modular design may allow users to configure the bowling ball support assembly with a desired number of link assemblies based on specific requirements or preferences. In some cases, the bearing pins connecting adjacent link assemblies may be removable to facilitate addition or removal of link assemblies from the chain formation. A user may remove a bearing pin from a connection point between two link assemblies, separate the link assemblies at that connection point, and insert or remove one or more link assemblies before reconnecting the chain formation with the bearing pin. The modular design may allow the bowling ball support assembly to be reconfigured between different radial configurations, such as transitioning from a pentagonal configuration to a square configuration or a hexagonal configuration by adding or removing link assemblies.

The bowling ball support assembly may allow users to change the type of roller ball bearing assemblies for customization. In some cases, the roller ball bearing assemblies may be removable from the roller ball bearing support platforms to permit replacement with different types of roller ball bearing assemblies. A user may remove a roller ball bearing assembly from a roller ball bearing assembly seat and install a replacement roller ball bearing assembly having different characteristics. The replacement roller ball bearing assembly may include a ball of a different size, which may affect the contact area between the ball and a bowling ball placed on the bowling ball support assembly. In some cases, the replacement roller ball bearing assembly may include a ball fabricated from a different material, which may affect the frictional characteristics or durability of the roller ball bearing assembly. The interchangeable roller ball bearing assemblies may allow users to select roller ball bearing assemblies that provide desired rotational characteristics for specific cleaning or maintenance operations. In some cases, the roller ball bearing assemblies may be configured with different bearing types, such as ball bearings, roller bearings, or needle bearings, and users may interchange between these different bearing types based on preferences or application requirements. The roller ball bearing assembly seats may be configured with standardized dimensions to accommodate multiple types of roller ball bearing assemblies, facilitating interchangeability between different roller ball bearing assembly configurations.

The angled stop plates may be designed with different angles to customize the range of motion between link assemblies. In some cases, the angled stop plates may be configured with steeper angles that restrict the angular displacement between adjacent link assemblies to a narrower range. The steeper angles may result in a tighter radial configuration where the link assemblies are positioned closer together around the perimeter of the radial arrangement. In some cases, the angled stop plates may be configured with shallower angles that permit a wider range of angular displacement between adjacent link assemblies. The shallower angles may result in a more open radial configuration where the link assemblies are positioned farther apart around the perimeter of the radial arrangement. The variable angles of the angled stop plates may allow the bowling ball support assembly to be configured for different radial arrangements, such as square, pentagonal, or hexagonal configurations, by selecting angled stop plates with angles corresponding to the desired configuration. In some cases, the angled stop plates may be removable and replaceable, allowing users to install angled stop plates with different angles to customize the range of motion between link assemblies for specific applications or preferences.

The angled stop plates may be designed with different shapes to customize the range of motion between link assemblies. In some cases, the angled stop plates may have planar surfaces that contact corresponding planar surfaces of adjacent link assemblies to limit angular displacement therebetween. In some cases, the angled stop plates may have curved surfaces that contact corresponding surfaces of adjacent link assemblies, which may provide a gradual transition in resistance as adjacent link assemblies approach the limits of their range of motion. The curved surfaces may provide a cushioning effect that reduces impact forces when adjacent link assemblies reach the limits of their angular displacement. In some cases, the angled stop plates may have stepped surfaces that provide multiple discrete angular positions at which adjacent link assemblies may be retained. The stepped surfaces may allow the bowling ball support assembly to be configured in multiple distinct radial arrangements by positioning adjacent link assemblies at different stepped positions. In some cases, the angled stop plates may include resilient portions fabricated from elastomeric materials that deform upon contact with corresponding surfaces of adjacent link assemblies, which may absorb impact forces and reduce noise when adjacent link assemblies reach the limits of their range of motion. The variable shapes of the angled stop plates may allow users to customize the operational characteristics of the bowling ball support assembly based on specific requirements or preferences.

In some cases, the link assemblies may include hollow sections configured for storing cleaning supplies or small tools. The hollow sections may be formed within the roller ball bearing support platforms or within the outer connection members of the link assemblies. The hollow sections may provide internal cavities accessible through openings or removable covers positioned on surfaces of the link assemblies. The hollow sections may be dimensioned to accommodate cleaning cloths, polishing compounds, or small brushes used during bowling ball maintenance operations. In some cases, the hollow sections may include compartmentalized regions that separate different cleaning supplies or tools within the internal cavities. The hollow sections may allow users to transport cleaning supplies together with the bowling ball support assembly, which may provide convenience by consolidating bowling ball maintenance equipment into a single portable unit. In some cases, the openings or removable covers providing access to the hollow sections may include sealing features such as gaskets or snap-fit closures that retain contents within the hollow sections during transport and prevent ingress of dust or debris.

In some cases, a dedicated storage compartment may be incorporated into one of the link assemblies. The dedicated storage compartment may be larger than the hollow sections described previously and may be configured to accommodate larger cleaning supplies or accessories. The dedicated storage compartment may be formed within a link assembly having an enlarged roller ball bearing support platform dimensioned to provide the additional internal volume for the storage compartment. In some cases, the dedicated storage compartment may include a hinged lid or sliding cover that provides access to contents stored therein. The hinged lid or sliding cover may include a latching mechanism that retains the lid or cover in a closed position during transport and use of the bowling ball support assembly. The dedicated storage compartment may be positioned within a link assembly located at a position in the chain formation that does not interfere with the radial configuration when the bowling ball support assembly is arranged for supporting a bowling ball. In some cases, the dedicated storage compartment may be incorporated into the master link assembly, which may provide convenient access to stored contents when the bowling ball support assembly is opened for transition between the radial configuration and the linear configuration.

In some cases, the surface texture of the balls in the roller ball bearing assemblies may include textured surfaces to provide different levels of grip or rotation characteristics. The textured surfaces may include raised features such as ridges, bumps, or nodules distributed across the spherical surfaces of the balls. The raised features may increase the coefficient of friction between the balls and a bowling ball placed on the bowling ball support assembly, which may provide increased grip during cleaning operations where a user applies rotational force to the bowling ball. The textured surfaces may reduce slippage between the balls and the bowling ball, which may allow users to rotate the bowling ball with greater control during polishing or inspection operations. In some cases, the textured surfaces may include recessed features such as grooves, dimples, or channels distributed across the spherical surfaces of the balls. The recessed features may reduce the contact area between the balls and the bowling ball, which may decrease rolling resistance and provide smoother rotation of the bowling ball during maintenance operations.

In some cases, the bowling ball support assembly may be designed with foldable components for more compact storage beyond the linear configuration. The foldable components may include outer connection members or inner connection members configured to fold against the roller ball bearing support platforms when the bowling ball support assembly is stored. The outer connection members and inner connection members may include hinge points or flexible joints that permit the connection members to pivot from an extended position during use to a folded position for storage. In the folded position, the connection members may lie substantially parallel to the roller ball bearing support platforms, reducing the lateral extent of each link assembly. In some cases, the foldable components may include the roller ball bearing assemblies, which may be configured to retract into the roller ball bearing support platforms or to pivot to a stowed position when the bowling ball support assembly is stored. The retractable or pivotable roller ball bearing assemblies may reduce the overall height of the bowling ball support assembly in the stored configuration, which may facilitate storage in shallow compartments or cases. The collapsible or foldable components may be configured to transition between the extended position and the collapsed or folded position without requiring tools, which may allow users to quickly prepare the bowling ball support assembly for storage or deployment.

The color and finish of the bowling ball support assembly components may be customizable to allow users to match the bowling ball support assembly to bowling equipment or personal preferences. In some cases, the link assemblies, the master link assembly, and other components of the bowling ball support assembly may be fabricated in a variety of colors. The colors may include standard colors such as black, white, red, blue, green, or yellow, as well as custom colors selected by users. In some cases, the components may be fabricated from colored materials where pigments or dyes are incorporated into the base material during manufacturing, which may provide coloration that extends throughout the thickness of the components and resists fading or wear over time. In some cases, the components may be coated with colored finishes applied to exterior surfaces thereof, such as paint, powder coating, or anodizing for metal components. The colored finishes may allow for a wider range of color options compared to colored base materials and may permit multi-color designs or patterns on individual components.

In some cases, the finish of the bowling ball support assembly components may include matte finishes that provide a non-reflective appearance. Matte finishes may reduce glare from overhead lighting in bowling alleys or other environments where the bowling ball support assembly may be used. In some cases, the finish may include glossy finishes that provide a reflective, polished appearance. Glossy finishes may be selected for aesthetic appeal or to match glossy bowling balls or other bowling equipment. In some cases, the finish may include textured finishes such as brushed, satin, or stippled surfaces that provide visual interest and may mask minor scratches or wear marks that accumulate during use. In some cases, the finish may include metallic finishes that simulate the appearance of metals such as chrome, gold, bronze, or copper. Metallic finishes may be applied to plastic components to provide a premium appearance without the weight or cost of metal construction. The customizable color and finish options may allow users to personalize the bowling ball support assembly to reflect individual style preferences or to coordinate with team colors, bowling league themes, or other bowling accessories.

In some cases, link assemblies of the bowling ball support assembly may incorporate brush attachments to facilitate a ball cleaning process. The brush attachments may be configured to engage with a surface of a bowling ball as the bowling ball is rotated on the bowling ball support assembly. The brush attachments may include bristles fabricated from materials such as nylon, polypropylene, or natural fibers that contact the bowling ball surface to remove lane oil, dirt, and debris. In some cases, the brush attachments may be mounted to the roller ball bearing support platforms of the link assemblies at positions adjacent to the roller ball bearing assemblies. The brush attachments may be oriented such that the bristles extend toward a center of the radial configuration where the bowling ball is positioned, allowing the bristles to contact the bowling ball surface during rotation. In some cases, the brush attachments may be removable from the link assemblies to permit replacement when the bristles become worn or to allow users to select brush attachments with different bristle characteristics for specific cleaning applications. The brush attachments may include mounting features such as snap-fit connections, threaded fasteners, or magnetic couplings that secure the brush attachments to the link assemblies while permitting removal when desired.

In some cases, link assemblies of the bowling ball support assembly may incorporate cleaning pad holders to facilitate the ball cleaning process. The cleaning pad holders may be configured to retain cleaning pads in contact with a surface of a bowling ball as the bowling ball is rotated on the bowling ball support assembly. The cleaning pads may be fabricated from absorbent materials such as microfiber, cotton, or synthetic sponge that absorb lane oil and cleaning solutions from the bowling ball surface. In some cases, the cleaning pad holders may include clamping mechanisms that grip edges of the cleaning pads to retain the cleaning pads in position during use. The clamping mechanisms may include spring-loaded jaws, clips, or straps that apply pressure to the cleaning pads to prevent displacement during bowling ball rotation. In some cases, the cleaning pad holders may be mounted to the roller ball bearing support platforms of the link assemblies at positions that allow the cleaning pads to contact the bowling ball surface without interfering with the roller ball bearing assemblies. The cleaning pad holders may be adjustable to accommodate cleaning pads of different sizes or thicknesses. In some cases, the cleaning pad holders may be removable from the link assemblies to permit cleaning or replacement of the cleaning pads and to allow users to configure the bowling ball support assembly with or without cleaning pad holders based on specific cleaning requirements.

The radial configuration of the bowling ball support assembly may be configured to nest within a complementary radial configuration of another identical bowling ball support assembly, allowing multiple bowling ball support assemblies to be vertically stacked when arranged in their radial configurations. The bottom flat surfaces of the roller ball bearing support platforms may be dimensioned and positioned to rest upon upper surfaces of the roller ball bearing support platforms of a lower bowling ball support assembly when the bowling ball support assemblies are stacked. The pentagonal or other radial configuration of an upper bowling ball support assembly may align with the corresponding radial configuration of a lower bowling ball support assembly such that the link assemblies of the upper bowling ball support assembly are positioned directly above the link assemblies of the lower bowling ball support assembly. The nesting configuration may reduce the vertical space occupied by multiple bowling ball support assemblies compared to stacking the bowling ball support assemblies without nesting, which may facilitate compact storage of multiple units in storage cabinets, equipment bags, or retail displays. In some cases, the nesting configuration may include alignment features such as projections, recesses, or interlocking surfaces that guide the upper bowling ball support assembly into proper alignment with the lower bowling ball support assembly during stacking. The alignment features may prevent lateral shifting of the stacked bowling ball support assemblies, which may provide stability when multiple units are stacked.

The mechanical components used for connections in the bowling ball support assembly may be readily available from general hardware stores or online retailers. In some cases, the bearing pins may be standard fasteners such as shoulder bolts, clevis pins, or dowel pins that are commercially available in various sizes and materials. The bearing pin nuts may be standard nuts such as hex nuts, lock nuts, or cap nuts that thread onto the bearing pins to secure the connections between adjacent link assemblies. The rollers may be standard roller components such as sleeve bearings, bushings, or roller sleeves that are commercially available from bearing suppliers or hardware distributors. The use of readily available mechanical components may simplify maintenance and repair of the bowling ball support assembly by allowing users to obtain replacement components from local hardware stores or online retailers without requiring specialized or proprietary parts. In some cases, the dimensions of the bearing pin holes, roller seats, and other connection features of the link assemblies may be configured to accommodate standard sizes of commercially available fasteners and roller components, which may provide users with flexibility in selecting replacement components based on availability, cost, or material preferences.

A number of implementations have been described. Nevertheless, it will be understood that various modifications may be made without departing from the spirit and scope of the disclosure. Accordingly, other implementations are within the scope of the following claims.

1. A bowling ball support assembly for supporting a bowling ball, comprising:
a plurality of interconnected link assemblies, each link assembly comprising a support platform;
a bearing assembly coupled to each support platform, wherein the bearing assemblies are configured to contact and rotationally support a bowling ball when the link assemblies are in a radial configuration; and
a closure mechanism configured to selectively secure the link assemblies in the radial configuration, wherein the link assemblies are transitionable between the radial configuration and a linear configuration.

2. The bowling ball support assembly of claim 1, wherein each link assembly comprises:
a first outer connection member;
a second outer connection member positioned in parallel to the first outer connection member, wherein the first outer connection member and the second outer connection member extend laterally in parallel from the support platform; and
an inner connection member extending from the support platform on an opposite side from the first outer connection member and the second outer connection member, wherein the inner connection member is configured to be positioned between the first outer connection member and the second outer connection member of an adjacent link assembly.

3. The bowling ball support assembly of claim 2, wherein the first outer connection member and the second outer connection member each comprise an outer member hole forming an axis of rotation, and wherein a bearing pin extends through the outer member holes to connect adjacent link assemblies.

4. The bowling ball support assembly of claim 3, wherein the bearing pin comprises a bearing pin head at one end and a bearing pin nut at an opposite end, wherein the bearing pin head is configured to seat within a bearing pin head seat flush below a top surface of the first outer connection member, and wherein the bearing pin nut is configured to seat within a bearing pin nut seat flush above a bottom surface of the second outer connection member.

5. The bowling ball support assembly of claim 2, wherein the inner connection member comprises a roller seat configured to receive a roller that is operably rotatable therewithin.

6. The bowling ball support assembly of claim 5, wherein the roller is positioned between the first outer connection member and the second outer connection member of an adjacent link assembly and is rotatable within the roller seat.

7. The bowling ball support assembly of claim 1, further comprising angled stop plates positioned between adjacent link assemblies to limit a range of motion between the adjacent link assemblies.

8. The bowling ball support assembly of claim 1, wherein the support platform of each link assembly includes a bottom flat surface, wherein the bottom flat surface of each support platform provides a stable base when the bowling ball support assembly is placed on a supporting surface by distributing the weight of the bowling ball across the plurality of link assemblies.

9. The bowling ball support assembly of claim 1, wherein the closure mechanism comprises an engagement member configured to engage with a roller seat of an adjacent link assembly to allow the bowling ball support assembly to be opened and closed.

10. A bowling ball support assembly, comprising:
a plurality of interconnected link assemblies arranged in a chain formation, each link assembly comprising:
a roller ball bearing support platform configured to support a roller ball bearing assembly;
a first outer connection member and a second outer connection member extending laterally in parallel from the roller ball bearing support platform; and
an inner connection member extending from the roller ball bearing support platform opposite the first outer connection member and the second outer connection member, the inner connection member configured to be positioned between the first outer connection member and the second outer connection member of an adjacent link assembly;
a roller ball bearing assembly coupled to each roller ball bearing support platform; and
a master link assembly configured to allow the chain formation to be opened and closed, wherein the link assemblies are configurable between a radial configuration for supporting a bowling ball and a linear configuration for storage.

11. The bowling ball support assembly of claim 10, wherein the first outer connection member and the second outer connection member each comprise an outer member hole, and wherein a bearing pin extends through the outer member holes to connect adjacent link assemblies.

12. The bowling ball support assembly of claim 11, wherein the bearing pin comprises a bearing pin head at one end and a bearing pin nut at an opposite end, wherein the bearing pin head is configured to seat within a bearing pin head seat flush below a top surface of the first outer connection member, and wherein the bearing pin nut is configured to seat within a bearing pin nut seat flush above a bottom surface of the second outer connection member.

13. The bowling ball support assembly of claim 10, wherein the inner connection member comprises an inner member roller seat configured to receive a roller that is operably rotatable therewithin.

14. The bowling ball support assembly of claim 13, wherein the roller is positioned between the first outer connection member and the second outer connection member of an adjacent link assembly and is rotatable within the inner member roller seat to provide an axis of rotation between adjacent link assemblies.

15. The bowling ball support assembly of claim 10, further comprising angled stop plates positioned between adjacent link assemblies to limit a range of motion between the adjacent link assemblies.

16. The bowling ball support assembly of claim 10, wherein the master link assembly comprises a master link outer member and a master link mounting cylinder extending from the master link outer member, wherein the master link mounting cylinder is configured to engage with an inner member roller seat of an adjacent link assembly.

17. A bowling ball support assembly, comprising:
a plurality of interconnected link assemblies arranged in a pentagonal configuration, each link assembly comprising:
a roller ball bearing support platform having a bottom flat surface;
a first outer connection member and a second outer connection member positioned in parallel and extending laterally from the roller ball bearing support platform, each of the first outer connection member and the second outer connection member comprising an outer member hole forming an axis of rotation;
an inner connection member extending from the roller ball bearing support platform opposite the first outer connection member and the second outer connection member, the inner connection member comprising an inner member roller seat and a roller received within the inner member roller seat and rotatable therewithin; and
a bearing pin extending through the outer member holes to connect adjacent link assemblies;
a roller ball bearing assembly coupled to each roller ball bearing support platform, wherein the roller ball bearing assemblies are arranged in an inwardly angled radial pattern to support a bowling ball in a rotational manner;
angled stop plates positioned between adjacent link assemblies to limit a range of motion between the adjacent link assemblies; and
a master link assembly comprising a master link mounting cylinder configured to engage with an inner member roller seat of an adjacent link assembly to allow the support assembly to be opened and closed.

18. The bowling ball support assembly of claim 17, wherein the bearing pin comprises a bearing pin head at one end and a bearing pin nut at an opposite end, wherein the bearing pin head is configured to seat within a bearing pin head seat flush below a top surface of the first outer connection member, and wherein the bearing pin nut is configured to seat within a bearing pin nut seat flush above a bottom surface of the second outer connection member.

19. The bowling ball support assembly of claim 18, wherein the roller is positioned between the first outer connection member and the second outer connection member of an adjacent link assembly and is rotatable within the inner member roller seat to provide an axis of rotation between adjacent link assemblies.

20. The bowling ball support assembly of claim 17, wherein the bottom flat surface of each roller ball bearing support platform provides a stable base when the support assembly is placed on a supporting surface by distributing the weight of the bowling ball across the plurality of link assemblies.
